(19) United States
(12) Patent Application Publication
(10) Pub. No.: US 2007/0253306 A1
(43) Pub. Date: Nov. 1, 2007

(54) Information Recording Medium, Method for Manufacturing Such Information Recording Medium, Processor for Such Information Recording Medium and Preparation Method for Using Such Information Recording Meduim, Information Recording Device

(75) Inventors: Yoshihisa Takahashi, Osaka (JP); Motoshi Ito, Osaka (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/576,619

(22) PCT Filed: Oct. 4, 2005
(86) PCT No.: PCT/JP05/18378

§ 371 Date: Apr. 4, 2007

(30) Foreign Application Priority Data
Oct. 5, 2004 (JP) 2004-292213

(51) Int. Cl. G11B 7/007

(52) U.S. Cl. 369/94; 369/275.1

(57) ABSTRACT

An information recording medium such as an optical disk in which each individual recording portion includes laminated multiple recording layers, and usability information relating to usability of the multiple recording layers of each individual recording portion is stored in a BCA (Burst Cutting Area), a DMA (Disc Management Area) and the like as predetermined locations.

### CROSS-REFERENCE TO RELATED APPLICATIONS

This application is a U.S. national phase application of PCT International Patent Application No. PCT/JP2005/18378, filed Oct. 4, 2005, claiming the benefit of priority of Japanese Patent Application No. 2004-292213 filed Oct. 5, 2004, all of which are incorporated by reference herein in their entirety.

### TECHNICAL FIELD

The present invention relates to an information recording medium, a manufacturing method thereof, a processing apparatus thereof, a preparation method for use thereof, an information recording method and an information recording apparatus.

### BACKGROUND ART

In recent years, large-capacity and replaceable information recording media and disk drive apparatuses for handling them are widely used.

An optical disk such as a DVD-RAM is well known as a conventional large-capacity and replaceable information recording medium. As an optical disk drive apparatus performs recording and reproduction by forming minute pits on the optical disk by using a laser beam, it is suitable for large-capacity and replaceable information recording (refer to a literature “120 mm (4, 7 Gbytes per side) and 80 mm (1, 46 Gbytes per side) DVD-Rewritable Disk (DVD-RAM),” Standard ECMA-330, December 2001 for instance).

FIG. 18 is an area configuration diagram of a general recordable optical disk. A disc-like recordable optical disk 1 has a large number of tracks 2 spirally formed thereon, and each individual track 2 has a large number of subdivided blocks 3 formed thereon. The block 3 is a unit of error correction, and is a minimum unit for performing recording and reproducing operation. In the case of the DVD-RAM for instance, it is a 1 ECC (32 Kbytes) size. It is a disk having only one recording layer on one surface, that is, a single-layer disk.

An area of the optical disk 1 is broadly divided into a BCA (Burst Cutting Area) 4, an inner circumference area 5, a data area 6 and an outer circumference area 7.

The BCA 4 is formed like a barcode for each individual disk by using a special apparatus in a manufacturing stage of the optical disk 1, and it is formed by removing a reflective film with a laser for instance. The BCA 4 is only recordable by using a special apparatus, and is not recordable by a general optical disk drive apparatus. The BCA 4 has identification information on each individual optical disk 1 and the like recorded thereon. There is only one BCA 4 on one surface even in the case of a multilayer disk including multiple recording layers on one surface.

The recording and reproduction of user data is performed on the data area 6.

The inner circumference area 5 and the outer circumference area 7 are the areas where management information of the optical disk 1 is recorded. In general, the inner circumference area 5 is an area called a lead-in area and the outer circumference area 7 is an area called a lead-out area in the case of the single-layer disk. In the case that an optical head (not shown) accesses an end of the data area 6, these areas play a role of an overlap width to be able to follow a track even when the optical head overruns.

Furthermore, in recent years, development of instruments which realize a still larger capacity is underway, from a DVD using a red laser as a laser to a Blu-ray Disc (hereafter referred to as a BD) using a blue laser of a short wavelength. On the other hand, development of a multilayer disk including multiple recording layers is also underway, such as a two-layer disk having two recording layers stacked on one surface.

A manufacturing technology of the multiple recording-layer disk has just been developed, and it glues the multiple recording layers together on the same surface. Therefore, each of the recording layers has a different recording property. Depending on circumstances, it often happens that the disk thereby completed has no problem in the recording property of a certain recording layer while the recording property of another recording layer is at an insufficient product level. To be more specific, there has been a problem that a probability of completing the disk of which all the recording layers are at a sufficient product level, that is, yield is very low in a disk manufacturing process. For that reason, a disk manufacturer cannot keep a disk unit price low, which is disadvantageous for a general user.

For instance, in the case of the multilayer disk, if only the recording property of one recording layer of the two-layer disk is at the product level by way of example, it has been desired to use the disk as if a single-layer disk. In the case of a rewritable disk, there have been needs to use it as a write-once optical disk which can perform recording just once even when unable to repeatedly perform recording depending on conditions of the recording layer.

To be more specific, if the yield can be virtually improved by handling it as if the single-layer disk or the write-once optical disk, it may be expected to keep the unit price low by reducing unnecessary cost due to defective products.

The present invention has been made in view of the problem, and an object thereof is to provide an information recording medium including multiple recording layers and the like which can make efficient use of the recording layers according to an extent of a problem if the problem occurs to one of the recording layers when manufacturing the information recording medium.

### DISCLOSURE OF THE INVENTION

The 1st aspect of the present invention is an information recording medium comprising a plurality of recording layers, wherein usability information relating to usability of each of the plurality of recording layers is stored at a predetermined location.

The 2nd aspect of the present invention is the information recording medium according to the 1st aspect of the present invention, wherein the usability information indicates that the recording layers are in at least one of the states of (1) unrecordable, and (2) recordable.

The 3rd aspect of the present invention is the information recording medium according to the 2nd aspect of the present invention, wherein (2) recordable of the usability information indicates one of the states of (2a) recordable only once and (2b) repeatedly recordable.

The 4th aspect of the present invention is the information recording medium according to the 1st aspect of the present invention, wherein all the plurality of recording layers are in a shape of an annular ring and the predetermined location is provided further on the inner circumference side than the annular ring.

The 5th aspect of the present invention is the information recording medium according to the 4th aspect of the present invention, wherein the predetermined location is a BCA (Burst Cutting Area).

The 6th aspect of the present invention is the information recording medium according to the 1st aspect of the present invention, which is an optical disk, wherein all the plurality of recording layers are in the shape of an annular ring and the predetermined location is an arbitrary location on the recording layer.

The 7th aspect of the present invention is the information recording medium according to the 6th aspect of the present invention, wherein the arbitrary location is a disc management area (DMA) in which management information relating to the optical disk is recorded.

The 8th aspect of the present invention is the information recording medium according to the 7th aspect of the present invention, wherein:

the DMA has disk management information which is management information relating to the optical disk and a DDS (Disc Definition Structure) including positional information on a position for placing the disk management information stored therein; and

the predetermined location is a location for storing the disk management information or a location for storing the DDS.

The 9th aspect of the present invention is a recording apparatus of an information recording medium for recording information on the information recording medium including a plurality of recording layers, comprising a description instrument which stores a result of usability of each of the plurality of recording layers as usability information relating to the usability which is the information at a predetermined location.

The 10th aspect of the present invention is the recording apparatus of an information recording medium according to the 9th aspect of the present invention, wherein the usability information indicates that the recording layers of the information recording medium are in at least one of the states of (1) unrecordable, and (2) recordable.

The 11th aspect of the present invention is the recording apparatus of an information recording medium according to the 10th aspect of the present invention, wherein (2) recordable of the usability information indicates one of the states of (2a) recordable only once and (2b) repeatedly recordable.

The 12th aspect of the present invention is the recording apparatus of an information recording medium according to the 9th aspect of the present invention, wherein:

the information recording medium is an optical disk in which the plurality of recording layers are formed on a disk substrate;

all the plurality of recording layers are in a shape of an annular ring;

an examination of the usability is performed by optically recording or reproducing the information on each of the recording layers; and

the predetermined location is an arbitrary location selected from at least the disk substrate and each of the recording layers.

The 13th aspect of the present invention is the recording apparatus of an information recording medium according to the 12th aspect of the present invention, wherein the arbitrary location is a BCA (Burst Cutting Area) which is formed further on the inner circumference side than the annular ring of the plurality of recording layers of the disk substrate.

The 14th aspect of the present invention is the recording apparatus of an information recording medium according to the 12th aspect of the present invention, wherein the arbitrary location is a disc management area (DMA) in which management information relating to the optical disk is recorded.

The 15th aspect of the present invention is a manufacturing apparatus of an information recording medium including a plurality of recording layers, comprising:

a gluing instrument which creates a medium body including the plurality of recording layers by laminating and gluing together a plurality of recording films on a disk substrate; and

the recording apparatus of the information recording medium according to the 9th aspect of the present invention,

wherein the information recording medium having the usability information recorded thereon is created by recording the usability information on the medium body.

The 16th aspect of the present invention is a recording method of an information recording medium for recording information on an information recording medium including a plurality of recording portions, comprising:

(a) a step of examining usability of each of the plurality of recording layers; and

(b) a step of storing a result of the examination as usability information relating to the usability which is the information at a predetermined location.

The 17th aspect of the present invention is the recording method of an information recording medium according to the 16th aspect of the present invention, wherein the usability information indicates that the recording layers of the information recording medium are in at least one of the states of (1) unrecordable, and (2) recordable.

The 18th aspect of the present invention is the recording method of an information recording medium according to the 17th aspect of the present invention, wherein (2) recordable of the usability information indicates one of the states of (2a) recordable only once and (2b) repeatedly recordable.

The 19th aspect of the present invention is a manufacturing method of an information recording medium including a plurality of recording layers, comprising:

(a) a step of creating a medium body including the plurality of recording layers by laminating and gluing together a plurality of recording films on a disk substrate; and

(b) a step of recording the usability information on the medium body by the recording method of an information recording medium according to the 16th aspect of the present invention.

The 20th aspect of the present invention is a processing apparatus of an information recording medium for performing a process of rendering the information recording medium according to the 1st aspect of the present invention usable, comprising:

a readout instrument which reads out the usability information from the predetermined location of the information recording medium;

a determination instrument which determines a degree of usability as to each of the plurality of recording layers based on the usability information read out by the readout instrument; and

an assignment instrument which renders data areas in the recording layers of which usability is determined at least not to be adverse by the determination instrument as recordable or reproducible logical spaces and assigns logical addresses which are addresses of the logical spaces.

The 21st aspect of the present invention is the processing apparatus of an information recording medium according to the 1st aspect of the present invention, wherein the assignment instrument assigns the logical addresses in order from the recording layer close to the side where the readout is performed out of the recording layers of which usability is determined at least not to be adverse.

The 22nd aspect of the present invention is the processing apparatus of an information recording medium according to the 16th aspect of the present invention, wherein the assignment instrument assigns the logical addresses in a direction matching with an assignment direction of physical addresses of each of the recording layers of which usability is determined at least not to be adverse and an assignment direction of physical addresses among the recording layers.

The 23rd aspect of the present invention is a preparation method for use of an information recording medium for rendering the information recording medium according to the 1st aspect of the present invention usable, comprising:

(a) a step of reading out the usability information from the predetermined location of the information recording medium;

(b) a step of determining at least whether or not usability is adverse as to each of the plurality of recording layers based on the usability information read out in the step (a); and

(c) a step of rendering data areas in the recording layers of which usability is at least determined not to be adverse in the step (b) as recordable or reproducible logical spaces and assigning logical addresses which are addresses of the logical spaces.

According to the present invention described above, it is possible, for instance, to include a layer status management flag for determining whether or not the information recording medium is recordable for each recording layer and thereby make a two-layer disk having a second-layer of a bad recording property look like a single-layer disk capable of using only a first layer. Therefore, the recording apparatus can perform recording and reproduction by handling the disk just like an ordinary disk. To be more specific, even if a completed disk has a certain recording layer of bad recording property, it can be handled as a usable disk so as to allow yield of a disk manufacturing process to be dramatically improved and also allow manufacturing cost to be significantly reduced. As the manufacturing cost of the disk is reduced, reduction in a unit price of the disk is also expected, which is anticipated to be a great merit for a user who purchases the disk.

According to the present invention, even if a problem occurs to one of the recording layers when manufacturing the information recording medium including multiple recording layers, it is possible to make efficient use of the recording layers according to an extent of the problem. Therefore, it is possible to provide the information recording medium without discarding it.

### BRIEF DESCRIPTION OF THE DRAWINGS

FIG. 1 is a sectional view of a two-layer optical disk according to first to third embodiments of the present invention;

FIG. 2 is an explanatory diagram of a data structure of a disk definition structure according to the first embodiment of the present invention;

FIG. 3 is a data structure diagram of recording layer quality information according to the embodiment of the present invention;

FIG. 4 is a diagram showing a disk manufacturing procedure according to the first embodiment of the present invention;

FIG. 5 is a block diagram of an optical disk recording and reproducing apparatus 100 according to the first embodiment of the present invention;

FIGS. 6 are explanatory diagrams of correspondences between physical addresses and logical addresses;

FIG. 7 is a diagram showing a disk reading (running) procedure according to the first embodiment of the present invention;

FIGS. 8 are explanatory diagrams showing examples of order of using recording layers according to the embodiment of the present invention;

FIG. 9 is an explanatory diagram of the data structure of the disk definition structure according to a second embodiment of the present invention;

FIG. 10 is a block diagram of the optical disk recording and reproducing apparatus 100 according to the second embodiment of the present invention;

FIG. 11 is an explanatory diagram of a command CDB of a Format command;

FIG. 12 is a diagram showing a setup procedure of the recording layer quality information according to the second and third embodiments of the present invention;

FIG. 13 is a diagram showing a disk reading (running) procedure according to the second embodiment of the present invention;

FIG. 14 is an explanatory diagram of the data structure of the disk definition structure according to the third embodiment of the present invention;

FIG. 15 are explanatory diagrams of a structure and attributes of defect entries according to the third embodiment of the present invention;

FIG. 16 is a diagram showing a disk reading (running) procedure according to the third embodiment of the present invention;

FIG. 17 is a block diagram of a manufacturing apparatus and a recording apparatus of an optical disk according to the first to third embodiments of the present invention; and

FIG. 18 is an area configuration diagram of an optical disk.

### DESCRIPTION OF SYMBOLS

1 Optical disk
2 Track
3 Block
4 BCA
5 Inner circumference area
6 Data area
7 Outer circumference area
10, 11, 12, 13 DMA
14 User data area
15 Spare area
20 Disk definition structure (DDS)
21 Disk management information
30, 45 Recording layer quality information
31, 46 Other information
40 Disk definition structure identifier
41 Disk management information head position information
42 Spare area size information
43 Logical space head position information
44 Logical space size information
47 Defect list header
48 Defect entry
50 Enable flag
51 Quality information
70 Defect attribute information
71 Defect position information
72 Defect sub information
100 Optical disk recording and reproducing apparatus
110 Order processing portion
120 Recording control portion
130 Reproduction control portion
140 BCA readout portion
150 Management information storage buffer
160 Data buffer
170 Recording layer quality information control portion
171 Recording layer quality information determining portion
172 Address translation processing portion
173 Recording layer quality information setting portion
180 I/O bus
501 Optical disk substrate
502 0-th recording layer
503 First recording layer

### BEST MODE FOR CARRYING OUT THE INVENTION

Hereunder, embodiments of the present invention will be described by using the drawings.

The embodiments of the present invention will be described by using an optical disk as an information recording medium of the present invention.

### First Embodiment

(1) Optical Disk Configuration

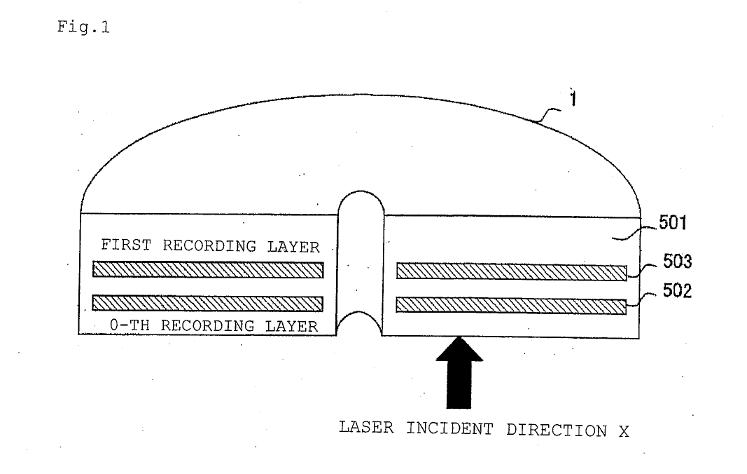

FIG. 1 is a schematic view of a cross-section of a two-layer disk including two recording layers as an example of a multilayer optical disk.

A two-layer optical disk 1 has a configuration in which recording films to be the two recording layers (a 0-th recording layer 502 and a first recording layer 503) are glued together on an optical disk substrate 501. A practical optical disk is created by gluing multiple layers (films) such as a protection layer together in addition to these recording layers. In this embodiment, however, a further detailed description will be omitted.

Here, the recording layers are called the 0-th recording layer 502 and the first recording layer 503 in order from a laser incident direction X side. The recording layers are equivalent to a recording portion of the present invention.

Hereunder, a description will be given by taking the two-layer disk as an example of the multilayer disk unless noted otherwise in particular.

(2) Data Structure

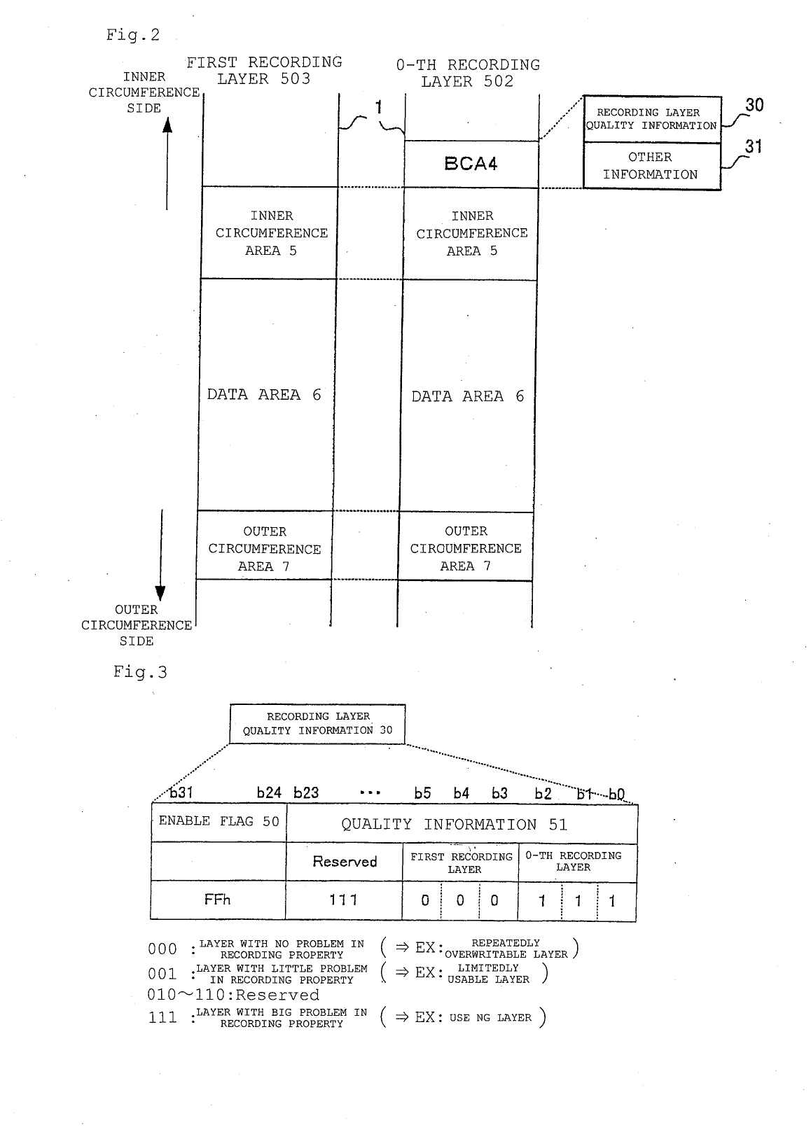

FIG. 2 is a data structure diagram of an optical disk 1 according to a first embodiment of the present invention

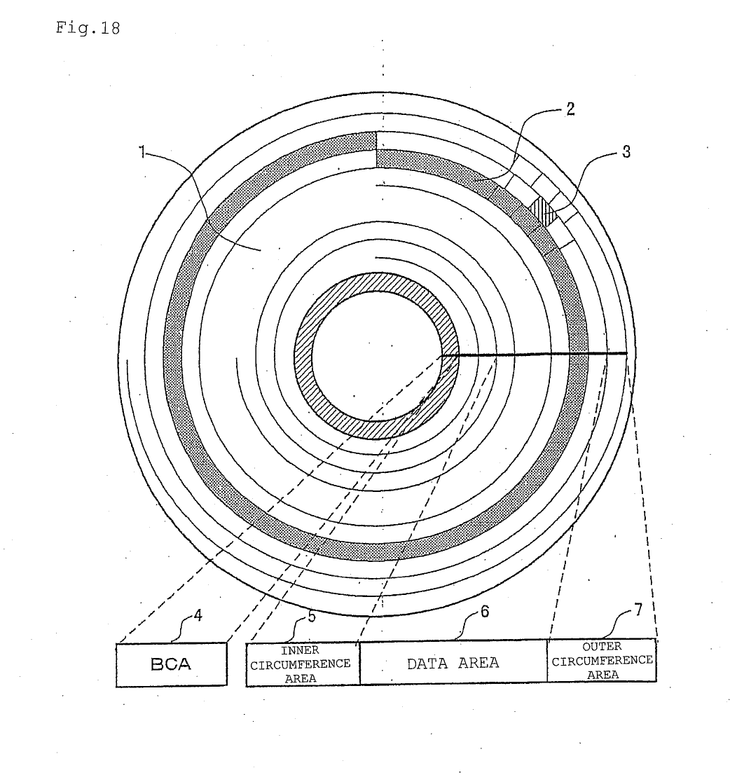

The optical disk 1 is broadly divided into a BCA 4, an inner circumference area 5, a data area 6 and an outer circumference area 7. In the configuration diagram shown in FIG. 18, each of the recording layers has an annular shape as shown in FIG. 18, and the BCA 4 is provided further on the inner circumference side than the recording layers.

The data area 6 is an area in which a user can record arbitrary information, such as real-time data including music and video and computer data including text and a database.

The inner circumference area 5 is an area located further on the inner circumference side than the data area 6 in a radial direction of the optical disk 1. The outer circumference area 7 is an area located further on the outer circumference side than the data area 6 in the radial direction of the optical disk 1. These areas are the areas which include management information on the optical disk 1 and play a role of preventing an overrun of an optical pickup (not shown).

In the case of the two-layer disk shown in FIG. 1, the inner circumference area 5 of the 0-th recording layer 502 is called a lead-in area and the inner circumference area 5 of the first recording layer 503 is called a lead-out area. In the case of a single-layer disk, there is only the 0-th recording layer, where the inner circumference area 5 is the lead-in area and the outer circumference area 7 is the lead-out area.

The BCA 4 is an area located innermost in the radial direction of the optical disk 1. The BCA 4 is formed like a barcode for each individual disk by using a special apparatus (not shown) in a manufacturing stage of the optical disk 1, where it is formed by removing a reflective film with a laser for instance. The BCA 4 cannot be recorded by an optical disk recording and reproducing apparatus 100 described later.

As for the first embodiment and FIG. 2, a description will be given on the assumption that the BCA 4 is placed on the 0-th recording layer 502 in order to facilitate the description. In reality, however, BCA4 is placed on a different layer (such as the protection layer) than the recording layer.

The BCA 4 includes recording layer quality information 30 as an example of usability information of the present invention and other information 31 (copy protection information and the like).

As for the optical disk 1, the area configuration diagram of the 0-th recording layer 502 matches with the area configuration diagram 18 of a conventional general optical disk while the area configuration diagram of the first recording layer 503 matches with the one excluding the BCA 4 from the configuration of the area configuration diagram 18.

FIG. 3 is an explanatory diagram showing the data structure of the recording layer quality information 30.

The recording layer quality information 30 is the information indicating quality in use of all the recording layers of the optical disk 1, and includes an enable flag 50 for indicating whether or not the information is valid and quality information 51 for indicating a degree of quality in use of each individual recording layer. In the case of the two-layer disk as with the first embodiment for instance, bits corresponding to the 0-th recording layer 502 and the first recording layer 503 as the quality information 51 are assigned (3 bits per layer in the example of FIG. 3), and values of the bits indicate the degree of a problem in a recording property of a corresponding recording layer.

In the case that the value of the bits is (000) for instance, it means that there is no problem in the recording property and repeated overwrite recording is possible. In the case that the value of the bits is (001), it means that there is a little problem in the recording property and the number of times of repeated overwrite recording is limited; for instance, just one recording is possible (write-once).

In the case that the value of the bits is (111), it means that there is a great problem in the recording property and it is unusable. The information in the other five cases of (010) to (110) is used as preliminary information for displaying other necessary information. In the case of FIG. 3, it indicates a state that the 0-th recording layer 502 is unusable and the first recording layer 503 is in a usable state. In this case, the most serious problem of practical disk defects is the unusable state of a recording layer, and so a minimum requirement of determination is to determine whether or not it is unusable.

In the case that the enable flag 50 is FFh, it indicates that the quality information 51 is valid. In the case of 00h, it indicates that the quality information 51 is invalid. However, the value of the enable flag is not limited to what is shown here and may be an arbitrary value.

FIG. 3 shows the example of the case where the recording layer quality information 30 is the information in a total 4-byte (32-bit) size of 1 byte of the enable flag 50 and 3 bytes of the quality information 51. However, the size of the recording layer quality information 30 (the enable flag 50 and the quality information 51) is not limited to what is shown here and may be an arbitrary value.

(3) Disk Manufacturing Process

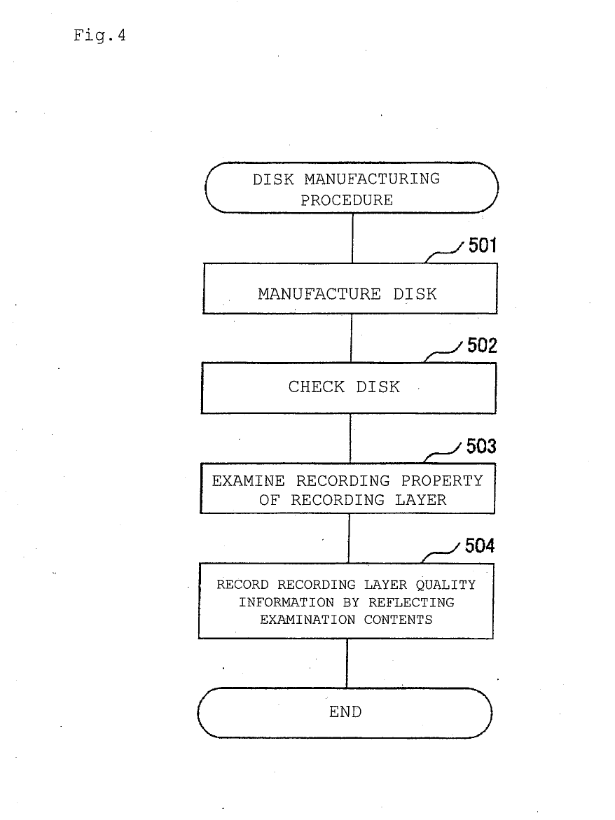

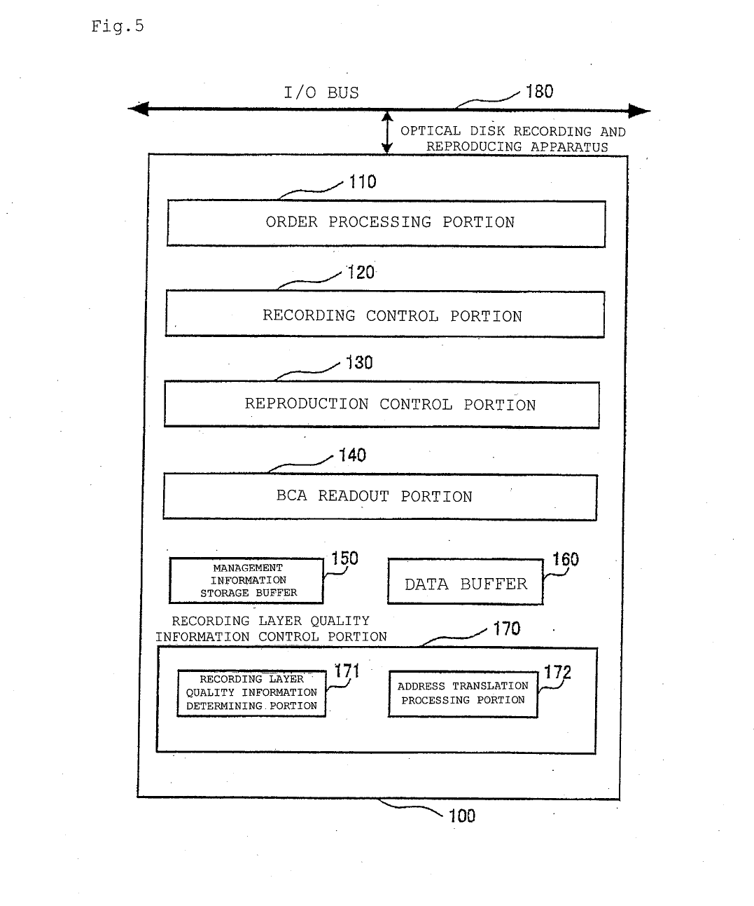

FIG. 4 is a flow diagram showing a general flow of a manufacturing process of the optical disk 1. The configuration of the optical disk 1 manufactured here is the same as that of the two-layer disk 1 shown in FIG. 1.

Step 501: The recording films to be the two recording layers (the 0-th recording layer 502 and the first recording layer 503) are glued together on an optical disk substrate 501 to manufacture the optical disk 1.

Step 502: The manufactured optical disk 1 is checked as to whether the recording films are correctly glued together and whether or not there are bubbles, dirt and the like between the films.

Step 503: The recording property of each of the recording layers is examined to check whether the disk is at an adequate product level. For instance, an error rate of a recording block called SER (Symbol Error Rate) is measured so as to examine whether the recording property of each of the recording layers is sufficient as a product (whether it is within the range stipulated as a specification).

Step 504: The recording layer quality information is recorded on the optical disk 1. Here, disk-specific information including the recording layer quality information 30 is recorded on the BCA 4. The recording layer quality information 30 recorded in this case is set a value (FFh in this case) indicating that the information is valid on the enable flag 50 and reflected a result of examining the recording property of each of the recording layers in the step 503 in the quality information 51, and in the case that there is a layer of which recording property is NG, data in which the bits corresponding to the layer are (111) is recorded as the recording layer quality information 30.

Here, the recording layer quality information 30 is recorded on the BCA 4 because a recording position needs to be a position where it is assured that the recording is securely performed. In other words, there is a possibility that the recording cannot be performed in an ordinary area of a recording layer because of its recording property. To be more specific, there is a possibility that it cannot be assured which recording layer the recording layer quality information 30 is recorded on when reading out the information.

The disk manufacturing process is completed by the above procedure. As for the steps, the step 501 is equivalent to (a) the step of creating the medium body in the manufacturing method of the information recording medium of the present invention. The steps 502 and 503 are equivalent to (a) the step of examining the usability in the recording method of the information recording medium of the present invention. The step 504 is (b) the step of storing the usability information at a predetermined location in the recording method of the information recording medium of the present invention and is equivalent to (b) the step of recording the usability in the manufacturing method of the information recording medium of the present invention.

It was described that the steps 501 to 504 are performed on each of the disks in the first embodiment. In the case of the SER measurement in the step 503 in particular, however, the recording is actually performed on the optical disk 1, that is, the examination is performed by writing the data to the recording layers. Therefore, there is no problem in the case of a rewritable disk capable of rewriting multiple times. In the case of the write-once optical disk which is recordable just once, however, the SER measurement once performed is equivalent to having performed the recording once so that the disk becomes unusable as a product.

It is possible for instance, by assuming such a case, to use as a sample one or a plurality of optical disks 1 arbitrarily selected out of the optical disks (a lot) manufactured at the same location, perform the step 503 to the sample, generate the recording layer quality information 30 by considering the result as the results of all the optical disks of the lot and perform the step 504 so as to manufacture the write-once optical disk by the same procedure. It goes without saying that this method is also applicable to a recordable optical disk such as a rewritable optical disk.

(4) Disk Readout Process

FIG. 5 is a block diagram of an optical disk recording and reproducing apparatus 100 according to the first embodiment of the present invention.

The optical disk recording and reproducing apparatus 100 is connected to a higher-level control apparatus (not shown) via an I/O bus 180. The higher-level control apparatus is typically a host computer.

The optical disk recording and reproducing apparatus 100 functionally includes an order processing portion 110 for processing an order from the higher-level control apparatus, a recording control portion 120 for performing a recording process for the recording layers of the optical disk 1, a reproduction control portion 130 for performing a reproduction process to the recording layers of the optical disk 1, a BCA readout portion 140 for reading out the information from the BCA 4, a management information storage buffer 150 for storing management information read out from the optical disk, a data buffer 160 for temporarily storing recording and reproduction data, and a recording layer quality information control portion 170 for controlling the recording layer quality information 30.

The BCA readout portion 140 reads out the information from the BCA 4, and stores the read-out information such as the recording layer quality information 30 in the management information storage buffer 150.

The recording layer quality information control portion 170 includes a recording layer quality information determining portion 171 and an address translation processing portion 172.

According to the recording layer quality information 30 readout from the management information storage buffer 150 by the BCA read out portion 140, the recording layer quality information determining portion 171 determines whether or not the recording layer quality information 30 is valid based on the enable flag 50 including the degree of usability (quality in use) of each individual recording layer based on the quality information 51.

In the configuration, the optical disk recording and reproducing apparatus 100 is equivalent to a processing apparatus for performing the process of rendering the information recording medium of the present invention usable. The reproduction control portion 130 and the BCA readout portion 140 are equivalent to a readout instrument of the present invention. The recording layer quality information determining portion 171 is equivalent to a determination instrument of the present invention, and the address translation processing portion 172 is equivalent to an assignment instrument of the present invention.

Here, addresses of the optical disk 1 will be briefly described.

In the case of performing an access process such as the recording and reproduction to the optical disk 1 in general, control is exerted by using an address physically assigned on the recording layer of the optical disk 1 (physical address: abbreviated as PBA hereafter) and an address virtually assigned to an area accessible by the user, that is, a logical space (equivalent to a data area 6 in the case of the first embodiment) (logical address: abbreviated as LBA hereafter).

To be more precise, in the case of a BD-RE which is a rewritable Blu-ray Disc for instance, the physical addresses correspond to an address called an ADIP which is given by using a warble of a recording groove on the disk and an address called an AUN which is given in the data recorded on the disk. In the case of the BD-RE, 3 ADIPs and 16 AUNs (one per 4 KBytes) are given in 1 cluster (64 KBytes) which is a unit for error correction.

There are the 0-th recording layer 502 and the first recording layer 503 in increasing order of the physical addresses.

Basically, one logical address corresponds to one predetermined physical address one-on-one.

The address translation processing portion 172 performs a translation process of the physical address (PBA) and the logical address (LBA) and the like based on the result determined by the recording layer quality information determining portion 171. To be more specific, it does not assign the logical address to the layer specified as unusable by the recording layer quality information determining portion 171 but only assigns the logical address to the layer determined to be usable.

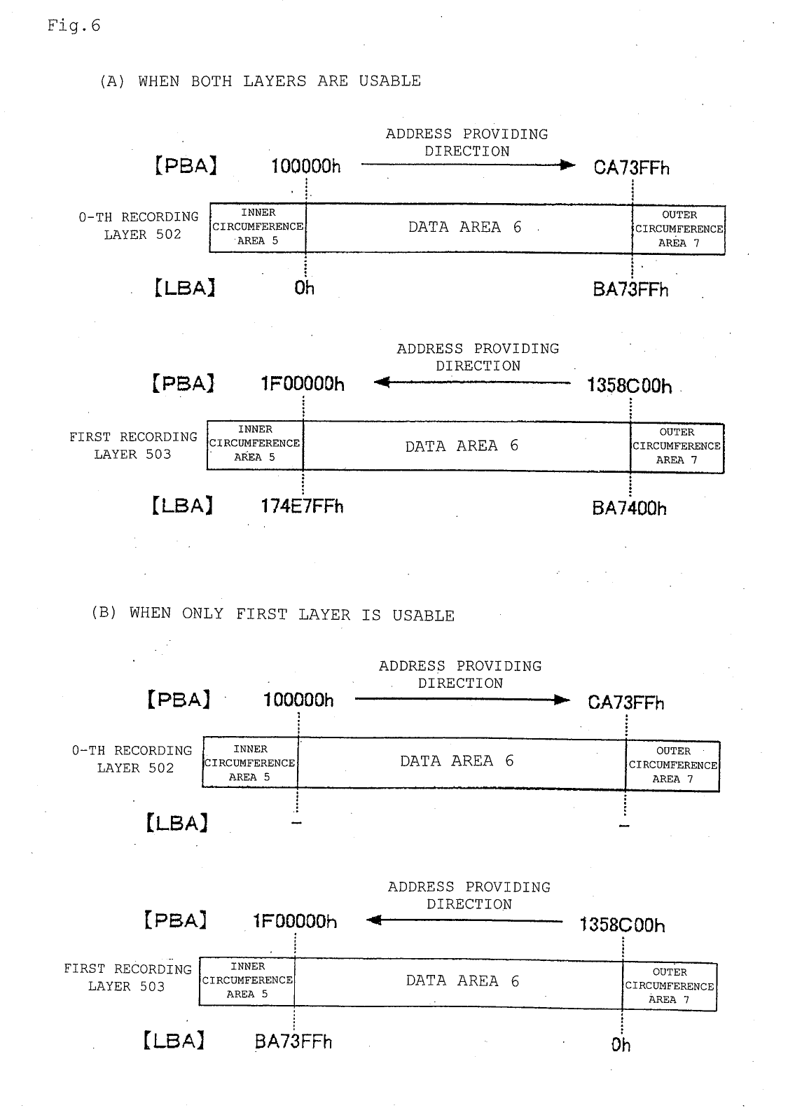

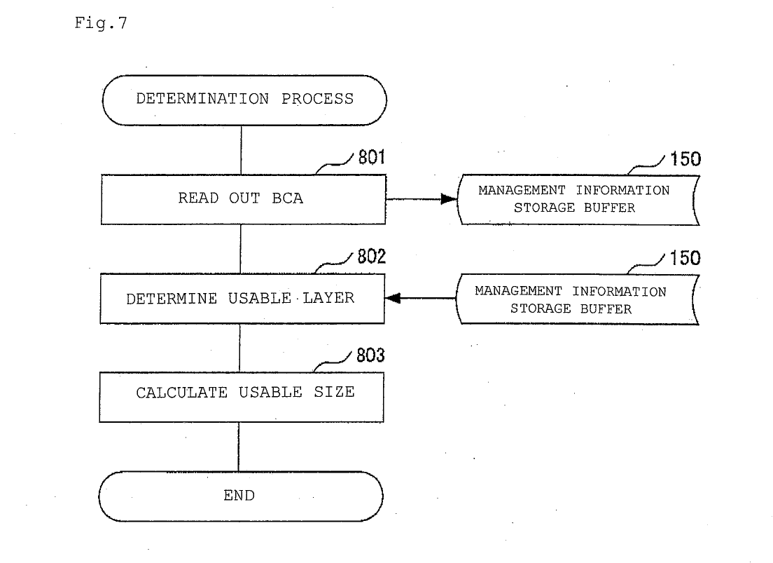

FIGS. 6 are explanatory diagrams showing correspondences between the physical address (PBA) and the logical address (LBA) of the BD-RE.

FIG. 6(A) is an explanatory diagram in the case that both the 0-th recording layer 502 and the first recording layer 503 are in the usable state. The addresses are assigned by setting the head (PBA=100000h) of a data area 6 of the 0-th recording layer 502 at LBA=0 h. The physical addresses are not successive between the end of the data area 6 of the 0-th recording layer 502 and the beginning of the data area 6 of the first recording layer 503. However, the logical addresses are successively assigned.

FIG. 6(B) is an explanatory diagram in the case that the recording layer quality information 30 is in the state shown in FIG. 3, that is, the 0-th recording layer 502 is in the unusable state and the first recording layer 503 is in the usable state. The 0-th recording layer 502 has no logical address assigned thereto, where the first recording layer 503 is virtually considered as the 0-th recording layer (virtual 0-th recording layer) and a virtual first recording layer is considered not to exist. And the beginning of the virtual 0-th recording layer, that is, the beginning of the data area 6 of the first recording layer 503, that is, the position of PBA=1358C00h is assigned as LBA=0h.

Both the FIGS. 6(A) and (b) are diagrams corresponding to the case where there is no spare area to be used as a replacement area of a defective block or the like in the data area 6. In the case that there is a spare area, the logical addresses are accordingly assigned.

FIG. 7 shows a brief summary of the above procedure.

FIG. 7 is a flow diagram showing a disk reading (running) procedure for the optical disk 1 of the first embodiment with the optical disk recording and reproducing apparatus 100.

Step 801: The BCA readout portion 140 reads out the information including the recording layer quality information 30 from the BCA 4 of the optical disk 1, and stores the read-out information in the management information storage buffer 150.

Step 802: The recording layer quality information control portion 170 determines whether or not the recording layer quality information 30 is valid. If valid, it determines a recording layer which is usable of the optical disk 1. To be more precise, the recording layer quality information determining portion 171 first determines whether or not the enable flag 50 in the recording layer quality information 30 read out by the management information storage buffer 150 is a value indicating valid (FFh in this case). If it is determined to be valid, it further examines the layer which is usable from the quality information 51, that is, the layer in the quality information 51 of which values of the bits are (000) or (001).

Step 803: The address translation processing portion 172 calculates an head position of the logical address and a usable size as the logical space, that is, an initial physical address of the data area 6 which is LBA=0h and a total size of the usable data area 6 based on the information on the layer determined to be usable.

In the case that there is a plurality of usable layers here, there are various thinkable methods of operation of the address translation processing portion 172, that is, methods of assignment of the logical space.

First, in the case that the layers of which values of the bits are (000) and the layers of which values of the bits are (001) in the quality information 51 are mixed in one disk, that is, in the case that there is mixture of the layers on which repeated overwrite recording is possible and the layers on which the number of repeated overwrite recording is limited such as a write-once layer, a method of assigning a series of logical addresses to be successive by the property, a method of assigning discrete logical addresses beginning with 0 in common by the property, and the like are used.

Consideration is given to a disk in which there are four recording layers for instance. In the case that there are multiple recording layers, a method called an opposite path is basically used to provide the physical addresses, where they are inversely provided to be in a unicursal form in each of the layers, such as in a direction from the inner circumference to the outer circumference for the 0-th recording layer and in a direction from the outer circumference side to the inner circumference side for the first recording layer. As for the disk in which there are four recording layers, in the case that all the four existing recording layers are usable, they are provided in order from the layer of the smallest physical address, such as the 0-th recording layer, the first recording layer and so on. In the case that there is an unusable recording layer, the following methods are thinkable.

1) A method of having the virtual 0-th recording layer, the virtual first recording layer and so on in order from the layer of the smallest physical address (laser incident direction).

2) A method of having the virtual 0-th recording layer, the virtual first recording layer and so on according to an address providing direction, and the like.

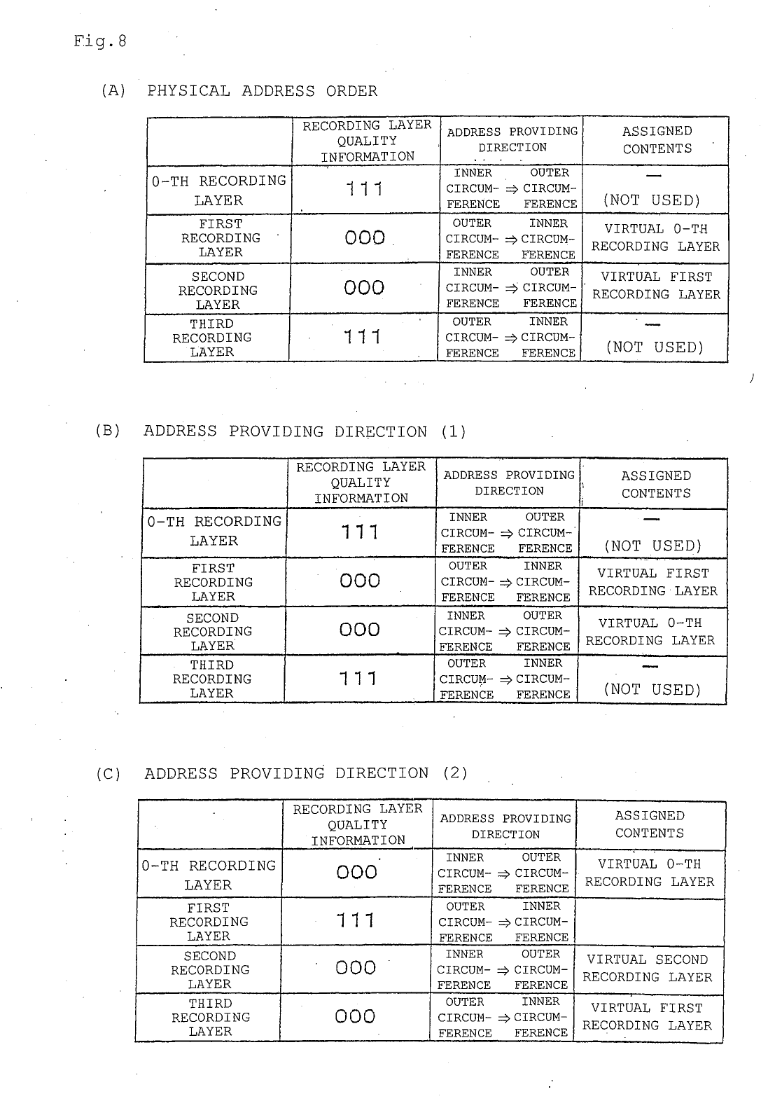

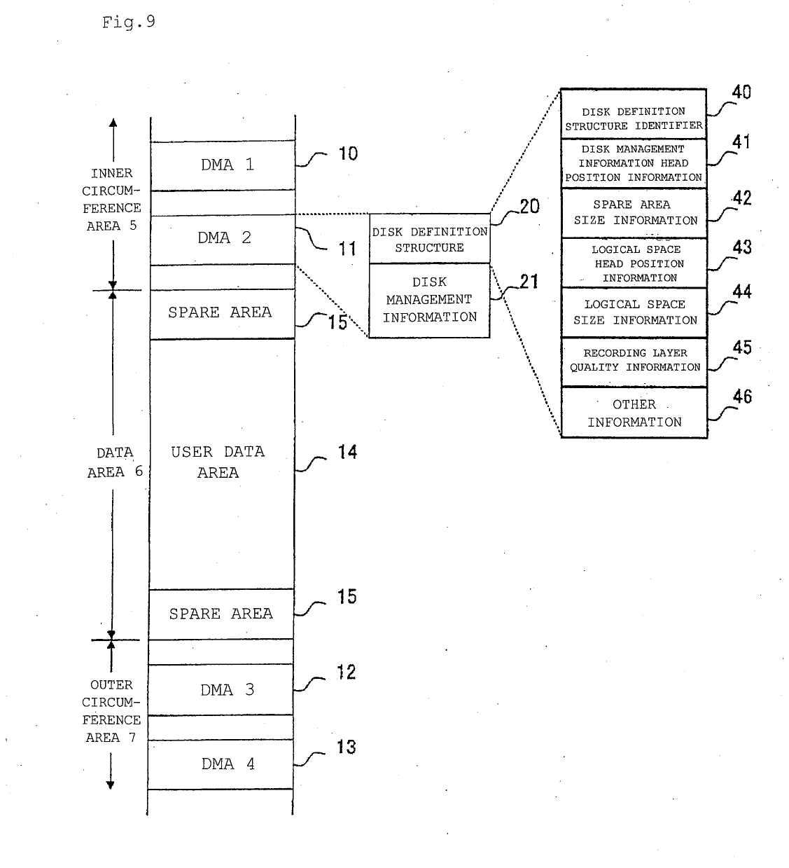

FIG. 8(A) shows the assignment method according to the physical addresses of the above 1). The recording layer in the usable state is assigned the logical addresses in order from the data area 6 of a layer having a smaller logical address, where the beginning of the data area 6 of the layer having the smallest logical address is LBA=0h. In the case of FIG. 8(A), the usable recording layers are adjacent two layers, and so the physical addresses are the opposite path and the assigned logical addresses are also the opposite path in the same assignment direction. In the case that an odd number of unusable recording layers are sandwiched among them, however, the sequence of the physical addresses is not the opposite path. As for the method of 1), the logical addresses should be assigned to have the virtual recording layers set up in order from the side close to the recording layer on the side where the data is read out. Therefore, the direction of the logical addresses is arbitrary. For the reason described later, however, it is desirable to assign the logical addresses so as to maintain the opposite path.

FIG. 8(B) shows the method of assigning the logical addresses according to the physical address providing direction of the above 2). The recording layer capable of using the address providing direction which is the same direction as the original 0-th recording layer is the head of the logical space, that is, the virtual 0-th recording layer. As the usable recording layers are adjacent two layers, the physical addresses are the opposite path. However, the virtual 0-th recording layer is assigned to a second recording layer further in the depth as a physical placement when viewed from the data readout side.

FIG. 8(C) shows another pattern of the method of assignment according to the physical address providing direction. The logical spaces for the recording layers are assigned so that the address providing direction of the usable recording layers continues from the inner circumference to the outer circumference and from the outer circumference to the inner circumference. In this case, the unusable first recording layer is sandwiched between the 0-th recording layer and the second recording layer, and so the adjacent usable 0-th recording layer and second recording layer have in the same physical address providing direction. As for the method of 2), an assignment of the logical addresses should be arranged to be the opposite path in the direction matching with the physical address providing direction. Therefore, a third recording layer of which address providing direction heads for the inner circumference from the outer circumference is eventually assigned as the first virtual recording layer subsequent to the virtual 0-th recording layer. Furthermore, a virtual second recording layer is positioned in the second recording layer which is physically an intermediate layer.

As indicated above, the idea is basically to assign them so that, while assigning them in order of the physical addresses, that is, in the order originally assigned to the recording layers, the assignment direction of the logical addresses maintains the opposite path, that is, they continue in order from the inner circumference to the outer circumference and from the outer circumference to the inner circumference. As regards the contents relating to the latter address assignment direction in particular, consideration is given to the point that it is possible, by successively assigning the logical addresses in the same direction as the physical addresses, to reduce seek processing between the inner circumference and the outer circumference even in the case that recording/readout access or the like astride the layers occurs so as to allow access processing speed to be higher.

The optical disk recording and reproducing apparatus 100 performs the reading process of the optical disk 1 by the above procedure.

As for the steps, the step 801 is equivalent to (a) the step of reading out the usability information in the preparation method for use of the information recording medium of the present invention. The step 802 is equivalent to (b) the step of determining at least whether or not usability is valid in the preparation method for use of the information recording medium of the present invention. And the step 803 is equivalent to (c) the step of assigning the logical addresses in the preparation method for use of the information recording medium of the present invention.

As described above, the optical disk recording and reproducing apparatus 100 can handle the recording layer specified as unusable by the recording layer quality information 30 as if nonexistent. To be more specific, in the case that the recording layer quality information 30 is in the state of FIG. 3, the disk is a two-layer disk in which there are two recording layers in reality. As the 0-th recording layer 502 is in the unusable state, however, the optical disk recording and reproducing apparatus 100 can handle this disk as if it is the single-layer disk in which there is only one recording layer of the first recording layer 503. In the case of the state of FIG. 3, it handles this disk as the single-layer disk in which the 0-th recording layer 502 is in the unusable state while only the first recording layer 503 is one layer capable of repeated recording. Depending on the contents of the quality information 51, however, it may be used as the multilayer disk having combined functions according to the usability of the recording layers, wherein the 0-th recording layer 502 is one layer only capable of writing once, only the first recording layer 503 is one layer capable of repeated recording, both the recording layers are only capable of writing once, and the like.

In the case that the same disk includes multiple layers of different kinds of usability (property), the method of controlling the recording and reproduction is different according to the usability. To be more precise, a write-once layer capable of recording just once can only accept a request for recording in an unrecorded area while a rewritable layer accepts a request for overwrite recording at an arbitrary location.

For that reason, in the case that the same disk includes multiple layers of different kinds of usability, the information indicating that the disk is the one including multiple layers of usability is provided in DI (Disc information) information or the like in the area (embossment area) in which the data is recorded in advance on manufacturing the BCA or the disk. The disk recording and reproducing apparatus determines a feature of the disk based on the information.

To recognize the state of the disk on the user (host apparatus) side such as a host computer, packet commands prescribed by the MMC (Multi Media Commands) standard, the SFF 8090 standard described later and the like are used between it and the disk recording and reproducing apparatus. For instance, the usability (property) of the disk can be grasped by using a “Get Configuration” command, and a logical space size can be grasped by using “Read Capacity” and “Read Track Information” commands.

In the present circumstances, however, these commands only address one kind of usability (property) as to one disk. Therefore, the user recognizes the usability (property) of the disk by extending the commands to the use in the cases of having multiple kinds of usability (property) and then obtains the logical space size by each kind of usability. This is the procedure by which the user recognizes the usability of each recording layer of the disk.

The methods taken up here are just examples. The methods are not limited to these as long as they have the same effects as above.

In the first embodiment, it was described that the enable flag 50 is included in the recording layer quality information 30. However, the enable flag 50 does not necessarily have to exist, in which case the same effects as described above can also be obtained.

In the first embodiment, the description was given on condition that the recording layer set up as unusable in the recording layer quality information 30 is totally unusable. As one of the methods, however, it is also possible to have an instrument, of the user's own will, which renders the unusable recording layer usable, that is, an instrument which ignores the recording layer quality information 30.

### Second Embodiment

(1) Optical Disk Configuration

As the configuration of the optical disk of the second embodiment is the same as the one described in the first embodiment, a description thereof will be omitted here.

(2) Data Structure

FIG. 9 is a data structure diagram of one recording layer of the optical disk 1 according to the second embodiment of the present invention.

The optical disk 1 is broadly divided into an inner circumference area 5, a data area 6 and an outer circumference area 7. Though not described in this drawing, there may also be the BCA 4 as shown in the first embodiment in addition to the three areas.

The data area 6 is composed of spare areas 15 and a user data area 14.

The user data area 14 is an area in which arbitrary information is recordable by the user, such as real-time data including music and video and computer data including text and a database.

The spare area 15 is an alternating area for recording the data instead of a certain block 3 in the user data area 14, which is the area used as the alternating area of a defective block in the case that the defective block is detected in the user data area 14 for instance. As shown in the drawing, there is one spare area 15 on each of the inner circumference area (that is, the lead-in area) and the outer circumference area (that is, the lead-out area) of the data area 6. However, it is free as to whether to have the spare area 15 existent and the number and placement thereof even in the case that they exist, which does not necessarily have to be the same as the drawing.

The inner circumference area 5 is an area located further on the inner circumference side than the data area 6 in the radial direction of the optical disk 1. The outer circumference area 7 is an area located further on the outer circumference side than the data area 6 in the radial direction of the optical disk 1. These areas are the areas which include management information on the optical disk 1 and play a role of preventing an overrun of an optical pickup (not shown).

The inner circumference area 5 includes a first DMA 10 (called a DMA 1 hereafter) and a second DMA 11 (called a DMA 2 hereafter). Both the DMA 1 and DMA 2 are the areas for recording the management information on the disk, such as the data structure and the information relating to defects of the optical disk 1.

The outer circumference area 7 includes a third defect management area 12 (called a DMA 3 hereafter) and a fourth defect management area 13 (called a DMA 4 hereafter). Both the DMA 3 and DMA 4 are the areas for recording the management information on the disk, such as the data structure and the information relating to defects of the optical disk 1.

Here, the DMA generally denotes Defect Management Area. It is also an area called Disk Management Area in a broader sense because it can include various kinds of information on the disk other than the defect management information. The DMA will be described as Disk Management Area information in the second embodiment.

Here, the DMAs 1 to 4 are the areas placed at predetermined positions of the optical disk 1 respectively.

Here, all the DMAs 1 to 4 have the same information multiply recorded therein. This is a preparation for the case that the DMAs 1 to 4 themselves are defective. It was conceived to allow the defect management information to be obtained if there is any one DMA which is correctly reproducible in the case that there is a DMA which is not correctly reproducible.

The DMAs 1 to 4 include a disk definition structure 20 (called a DDS 20 hereafter) and disk management information 21 respectively.

The disk management information 21 is the information which includes the management information relating to a recording state in the user data area 14, the information relating to an alternation process due to the defect (addresses of an alternation source and an alternation destination for instance) and the like.

The DDS 20 is the information which indicates the structure of the optical disk 1, and includes a disk definition structure identifier 40, disk management information head position information 41, spare area size information 42, logical space head position information 43, logical space size information 44, recording layer quality information 45, other information 46 and the like.

The disk definition structure identifier 40 is identifier information indicating that the information is the DDS 20.

The disk management information head position information 41 is information on a head position (=physical address) where the disk management information 21 is placed.

The spare area size information 42 is the information indicating the size of the spare area 15 placed in the data area 6.

The logical space head position information 43 is the head position information (=physical address) on the logical space accessible from the user.

The logical space size information 44 is the information indicating a final logical address, that is, the size of the logical space accessible from the user.

The recording layer quality information 45 is the information indicating the quality in use of all the recording layers of the optical disk 1. As it has the same contents as the recording layer quality information 30 described in the first embodiment, a description thereof will be omitted here.

Thus, the second embodiment is different from the first embodiment in that the recording layer quality information 45 is provided in the DMA, that is, on the recording layer.

(3) Disk Manufacturing Process

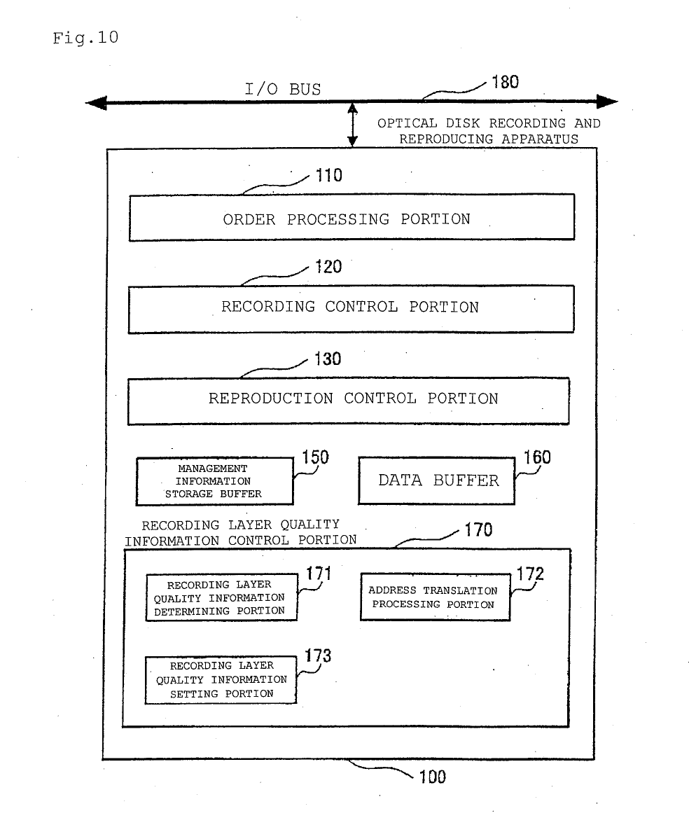

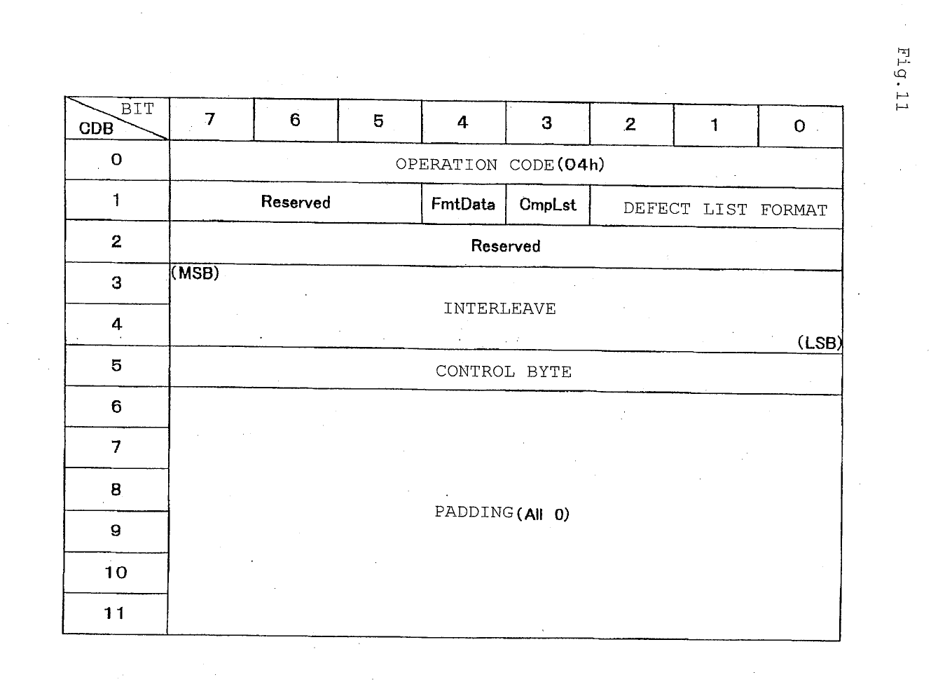

FIG. 10 is a block diagram of the optical disk recording and reproducing apparatus 100 according to the second embodiment of the present invention.

The optical disk recording and reproducing apparatus 100 is connected to a higher-level control apparatus (not shown) via an I/O bus 180. The higher-level control apparatus is typically a host computer.

The optical disk recording and reproducing apparatus 100 functionally includes an order processing portion 110 for processing an order from the higher-level control apparatus, a recording control portion 120 for performing a recording process to the optical disk 1, a reproduction control portion 130 for performing a reproduction process from the optical disk 1, a management information storage buffer 150 for storing the management information read out from the optical disk 1, a data buffer 160 for temporarily storing recording and reproduction data, and a recording layer quality information control portion 170 for controlling the recording layer quality information 30.

The optical disk recording and reproducing apparatus 100 may also include the BCA readout portion 140 as in the case of the first embodiment.

The recording layer quality information control portion 170 includes a recording layer quality information determining portion 171, an address translation processing portion 172 and a recording layer quality information setting portion 173.

The recording layer quality information determining portion 171 determines whether or not there is an unusable recording layer from the recording layer quality information 45 read out to the management information storage buffer 150 by the reproduction control portion 130.

The address translation processing portion 172 performs a translation process of the physical address (PBA) and the logical address (LBA) and the like based on the result determined by the recording layer quality information determining portion 171. To be more specific, it does not assign the logical address to the layer specified as unusable by the recording layer quality information determining portion 171 but only assigns the logical address to the layer determined to be usable. As the contents of operation of the address translation processing portion 172 are the same as those described in the first embodiment, a description thereof will be omitted here.

The recording layer quality information setting portion 173 creates the information to be recorded as the recording layer quality information 45 based on the contents specified by the higher-level control apparatus.

In the configuration, the reproduction control portion 130 is equivalent to the readout instrument of the present invention. The correspondence between each of the other portions and each of the instruments of the present invention is the same as that in the first embodiment.

The manufacturing process of the optical disk 1 in the second embodiment has the same procedure of the steps 501 to 503 as that described by using FIG. 4 in the first embodiment. Here, a description will be only given as to the contents of operation of the step 504 as the step of storing or recording the usability information on the recording method or manufacturing method of the information recording medium of the present invention at a predetermined location, which is different from the first embodiment. A description of the steps 501 to 503 will be omitted.

Step 504: The recording layer quality information 45 is recorded on the optical disk 1. Here, the information including the recording layer quality information 45 is recorded in the DMAs 1 to 4 of each of the recording layers. The recording layer quality information 45 recorded in this case reflects the result of examining the recording property of each of the recording layers in the step 503, where the data indicating the degree of the quality in use (whether or not unusable, only writing once is allowed, repeated recording is allowed and the like) of each individual recording layer as a bit value is recorded as the recording layer quality information 45.

The following shows an example of the step 504.

As an example of the recording process from the DMAs 1 to 4, there is a process called a physical format. The physical format is a process mainly for deciding the structure of the data area 6 (placement of the user data area 14 and the spare area 15 and the like), where the DDS 20 and the disk management information 21 are recorded in the DMAs 1 to 4. Here, the information equivalent to the DDS 20 and the disk management information 21 is stored in the management information storage buffer 150 for instance.

The physical format is specified from the higher-level control apparatus such as a host computer (not shown) by a “Format Unit” command (called a Format command hereafter) of the packet command prescribed by the Multi Media Command (MMC) standard and the SFF 8090 standard (also called a Mt. Fuji standard) prescribed by an industry organization of storage devices such hard disks and optical disk drives called SFF (Small Form Factor).

Here, the Format command will be briefly described.

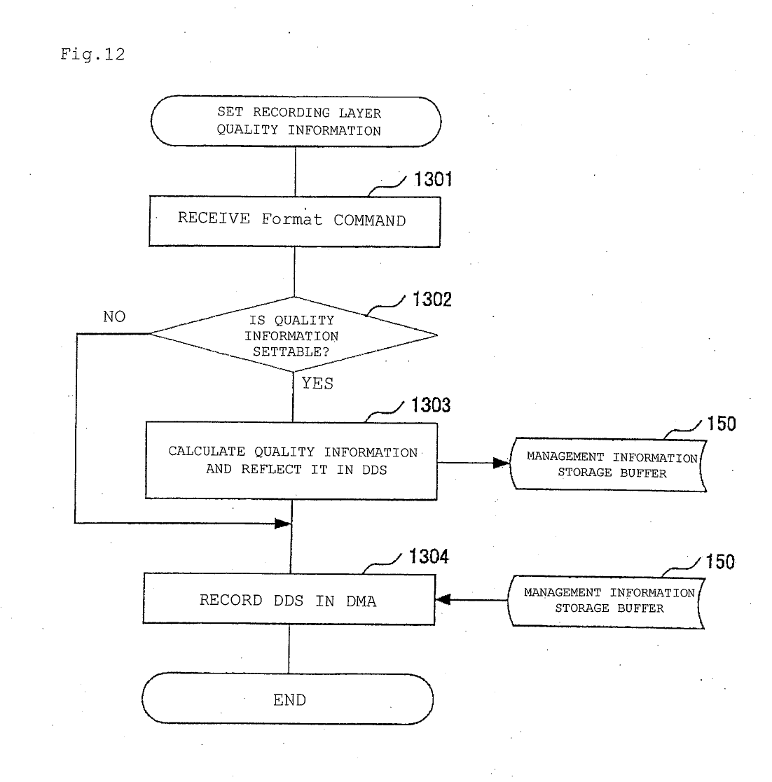

FIG. 11 is a diagram showing a command data structure of the Format command. The packet command is a data row of 12 bytes (in the case of ATAPI) called a CDB, and the Format command is a data row having the information as described in the drawing. The higher-level control apparatus orders a subject device (the optical disk recording and reproducing apparatus 100 in this case) to perform a Format process by transmitting (data-transferring) the CDB to the device via the I/O bus 180. There are several kinds of process contents to be implemented by the Format command. As for the kind of process to be executed, it is specified by the CDB shown in FIG. 12 and data for command execution control called a parameter list which is transmitted from the higher-level control apparatus.

Hereunder, a description will be given by taking as an example the case of recording the DDS 20 and the disk management information 21 in the DMAs 1 to 4 by using the Format command.

FIG. 12 is a flow diagram showing a detailed procedure of the step 504 in the second embodiment.

Step 1301: The higher-level control apparatus issues the Format command to the optical disk recording and reproducing apparatus 100. The optical disk recording and reproducing apparatus 100 receives the CDB and also receives the parameter list transmitted from the higher-level control apparatus. In this case, the information equivalent to the quality information 51 to be set up is transmitted from the higher-level control apparatus by including it in the CDB or the parameter list for instance.

Step 1302: The order processing portion 110 of the optical disk recording and reproducing apparatus 100 having received the Format command determines whether or not to record the information including the recording layer quality information 45, that is, whether or not to set up the recording layer quality information 45.

Here, the following methods are thinkable as the methods for determining whether or not to set up the recording layer quality information 45.

1) To newly provide a layer quality in use information setting mode to the Format command so as to set up the recording layer quality information 45 in the case that the mode is requested.

2) To set up the recording layer quality information 45 in the case that the DMA area of the optical disk 1 for performing the recording is in an unrecorded state (such as the case where the optical disk 1 is a virgin disk yet to be recorded).

3) A pattern of combination of the above 1) and 2).

As the second embodiment describes the processing in the disk manufacturing process, the above 3) is used as a method of determination. As it is the processing in the disk manufacturing process, however, it is assured in advance that the subject optical disk 1 to be recorded in the above 2) is a virgin disk. Therefore, the pattern of the above 1) is substantially used.

Step 1303: In the case that the order processing portion 110 determines to set up the recording layer quality information 45, the recording layer quality information setting portion 173 calculates the recording layer quality information 45 based on the quality information 51, and reflects it in the information equivalent to a DDS 20 included in the management information storage buffer 150. In this case, a value indicating being valid (FFh in this case) is set as the enable flag 50. As the usable recording layer is decided in this case, the logical space head position information 43, the logical space size information 44 and also the spare area size information 42 included in the DDS 20 are calculated and set up. To be more precise, in the case that the recording layer quality information 45 shown in FIG. 3 is set up on the two-layer disk shown in FIG. 2, the virtual 0-th recording layer becomes the first recording layer 503. Therefore, the initial physical address of the user data area 14 of the first recording layer 503 is set as the logical space head position information 43, size information on the user data area 14 of the first recording layer 503 is set as the logical space size 44, and the size of the spare area 15 of the virtual 0-th recording layer is set as the spare area size information 42.

As described in (4) disk readout process in the first embodiment, in the case that there are multiple usable layers in a four-layer disk for instance, various methods of assigning the logical spaces are thinkable. Therefore, the values to be set here are calculated according to the methods of assigning the logical spaces.

In the case that the order processing portion 110 determines not to set up the recording layer quality information 45, the recording layer quality information setting portion 173 reflects a default value (all 0 for instance) as the recording layer quality information 45 in the information equivalent to the DDS 20 included in the management information storage buffer 150 and moves on to a step 1304.

Step 1304: The order processing portion 110 requests the recording control portion 120 to record the DDS 20 and the disk management information 21 included in the management information storage buffer 150. And the recording control portion 120 records the DDS 20 and the disk management information 21 in the DMAs 1 to 4 of each of the recording layers.

Here, although probability is very low, there may be the case of a failure in the recording in the DMAs 1 to 4 of the recording layers determined to be normal and usable in a recording layer recording property examination in the step 503. In such a case, the disk is determined to be an unusable disk so that it is discarded and not shipped as a product. In the case that a recording result is different from the recording layer quality information 45 on completing the recording on all the recording layers, it is possible to recalculate the recording layer quality information 45 and record the DDS 20 in the DMAs 1 to 4 of each of the recording layers again.

The above procedure completes the process of the step 504, that is, the process of recording the recording layer quality information 45 on the optical disk 1.

As described above, the optical disk 1 of the second embodiment is shipped in the state of having already been physical-formatted in the manufacturing process.

It is desirable that the recording layer quality information 45 set up in the disk manufacturing process be limited as the information which is unchangeable even if the disk is physical-formatted by the user thereafter.

The second embodiment described that the DDS 20 and the disk management information 21 should be recorded in all the DMAs 1 to 4 of each of the recording layers. It is not always necessary, however, to record them in all the DMAs 1 to 4 of all the recording layers. To be more precise, it is sufficient, as the method for having the same effect, to perform the recording to the DMAs 1 to 4 of at least one of the recording layers (such as the recording layer rendered as the virtual 0-th recording layer) which is normally recordable while only recording in a specific DMA (such as the DMA 1) on the other recording layers.

The second embodiment took as an example the case of including the information equivalent to the recording layer quality information 45 to be set up in the CDB or the parameter list of the Format command. However, it is also possible, for instance, to store it in the management information storage buffer 150 provided to the optical disk recording and reproducing apparatus 100 in advance of the Format command process or render it as a nonvolatile memory (not shown) such as an EEPROM so as to perform the process by using this information.

The second embodiment showed an example of recording the DDS 20 including the recording layer quality information 45 in the DMAs 1 to 4 by using the Format command. However, it is not always necessary to use the Format command. It is also possible, for instance, to construct a new command for registering the recording layer quality information 45 and perform the recording by using that command.

(4) Disk Readout Process

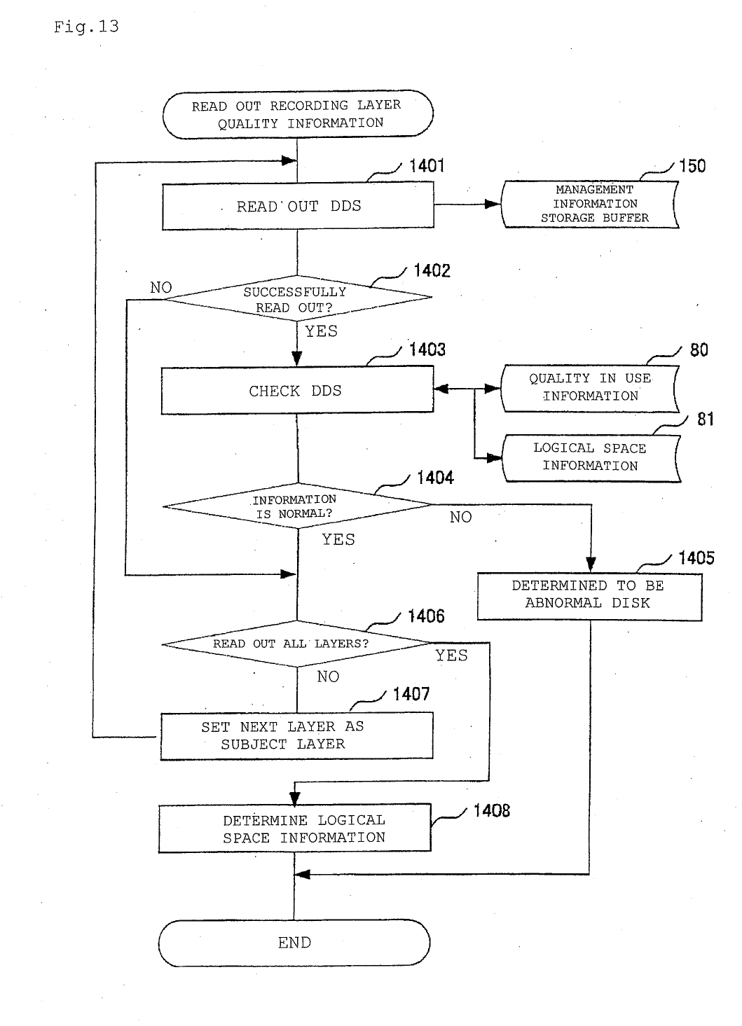

FIG. 13 is a flow diagram showing the disk reading (running) procedure for the optical disk 1 of the second embodiment by the optical disk recording and reproducing apparatus 100.

Step 1401: The reproduction control portion 130 reads out the DDS 20 and the disk management information 21 from the DMA area (DMAs 1 to 4) in a specified recording layer. The recording layer to be read out first is the 0-th recording layer in this case.

Step 1402: The reproduction control portion 130 determines whether or not the data was correctly read out in the step 1401.

If read out, the DDS 20 and the disk management information 21 are stored in the management information storage buffer 150, and the recording layer quality information 45 in the DDS 20 is stored in the memory (shared with the management information storage buffer 150 in this case) as quality in use information 80. In this case, the logical space head position information 43 and the logical space size information 44 may also be stored in the memory together.

If not correctly read out, it moves on to a step 1406.

Step 1403: The recording layer quality information determining portion 171 determines whether or not the read-out contents of the DDS 20 are correct. To be more precise, the recording layer quality information determining portion 171 compares the recording layer quality information 45 in the read-out DDS 20 with the quality in use information 80 held in the memory (shared with the management information storage buffer 150 in this case). In this embodiment, the logical space head position information 43 and the logical space size information 44 are stored together as logical space information 81 in the memory so as to use the information to determine whether or not the contents of the DDS 20 are correct as with the quality in use information 80. It is also possible, however, to obtain the same effect without always making a determination by using the information. When reading out the first layer in this case, nothing is stored in the quality in use information 80 and the logical space information 81. Therefore, the recording layer quality information 45 included in the DDS 20 read out in the step 1401 is stored as the quality in use information 80, and the logical space head position information 43 and the logical space size information 44 are stored as logical space information 81 in the memory, that is, the management information storage buffer 150.

Step 1404: As a result of checking the contents of the DDS 20 in the step 1403, the recording layer quality information determining portion 171 determines whether or not the DDS 20 is normal. To be more precise, it checks whether or not the recording layer quality information 45, the logical space head position information 43 and the logical space size 44 in the read-out DDS 20 match with the quality in use information 80 and the logical space information 81 in the management information storage buffer 150. If they match, it determines that the DDS 20 is correct information. If they do not match, it determines that the DDS 20 is incorrect information.

Step 1405: If the readout failed in the unrecorded state or if it is determined that the DDS 20 is incorrect information as a result of the step 1404, the readout process is finished and the optical disk 1 is determined as an abnormal disk. If it is determined to be an abnormal disk, performance for an abnormality disk is conducted, such as performing the physical format process indicated above again, using the disk by ignoring the recording layer quality information 45 as nonexistent, or determining this disk to be an unusable disk.

Step 1406: If it is determined that the DDS 20 is correct information as a result of the step 1404, the reproduction control portion 130 determines whether or not the readout of the DMA areas of all the recording layers has been completed.

Step 1407: If it is determined that the readout of the DMA areas of all the recording layers is yet to be completed as a result of the step 1406, the reproduction control portion 130 sets a next recording layer as a subject recording layer and returns to the step 1401 to perform the DMA readout process in the next recording layer. For instance, it sets a next recording layer to be in order of the first recording layer, the second recording layer and the third recording layer with the 0-th recording layer as the recording layer to be determined first.

Step 1408: If it is determined that the readout of the DMA areas of all the recording layers has been completed as a result of the step 1406, the recording layer quality information determining portion 171 handles the disk as a normal disk which is the disk having the recording layers as represented in the quality in use information 80 stored in the management information storage buffer 150 (memory) as usable/unusable and also having the logical spaces as represented in the logical space information 81. In the case that the readout of all the recording layers has failed, the logical space information cannot be obtained and the optical disk 1 is determined as a disk not to be handled.

The above completes the disk reading (running) process for the optical disk 1 in the second embodiment.

In the steps, the step 1401 is equivalent to (a) the step of reading out the usability information in the preparation method for use of the information recording medium of the present invention. The steps 1402 to 1407 are equivalent to (b) the steps of determining at least whether or not the usability is adverse in the preparation method for use of the information recording medium of the present invention. And the step 1408 is equivalent to (c) the step of assigning the logical addresses in the preparation method for use of the information recording medium of the present invention.

Here, it was described that the DDS 20 is read out from the DMA areas of all the recording layers, and it is determined that the optical disk 1 is normal only when all the pieces of information match. However, if the DDS 20 is correctly read out from one recording layer for instance, it is possible to handle the optical disk 1 as normal and the DDS 20 as the correct information at that time point so as to obtain the same effect as described here.

It was also described here that the DDS 20 and the disk management information 21 are read out from all the DMA areas of the DMAs 1 to 4. However, the disk management information 21 does not always have to be read out. And it is not always necessary to read out all the four DMA areas of all the recording layers, but the same effect as described here can be obtained by only reading out a predetermined DMA area.

It is also possible to hold the information of the recording layer of which DDS 20 is determined to be normal/incorrect information in the step 1404 in the management information storage buffer 150 so as to compare it with the quality in use information 80. To be more specific, it can be checked whether or not the readout from the recording layer specified as usable in the quality in use information 80 was successful and whether or not the readout from the recording layer specified as unusable failed. There is a possibility in general, however, that the readout from the recording layer specified as unusable may be successful. Therefore, it is possible to improve reliability of the data by checking whether or not the readout from the recording layer specified as usable was successful.

The second embodiment was described by taking as an example the case where it is not sure which recording layer has the DMA having been normally recorded. It is also possible, however, to provide a reference recording layer. To be more specific, in the case of the four-layer disk for instance, the 0-th recording layer is decided on as the reference recording layer for instance so that the 0-th recording layer is handled as capable of normal recording (with the recording property at a sufficient product level) without fail. And the disk which failed in the DMA recording of the 0-th recording layer may be caused not to be shipped as a product by considering it as a defective disk. Thus, the DDS 20 including the recording layer quality information 45 is correctly recorded in the DMA area of the 0-th recording layer as the reference recording layer without fail. Therefore, in the case of using this disk, the optical disk recording and reproducing apparatus 100 can obtain the same effect as described here by reading out the DDS 20 and the like from the DMA area of the 0-th recording layer, obtaining the recording layer quality information 45 and performing the processing thereafter based on this information.

The second embodiment was described on condition that the recording layer set up as unusable in the recording layer quality information 45 is totally unusable. As a method, it is also possible, according to the user's will, to include an instrument which renders the unusable recording layer usable, that is, an instrument which ignores the recording layer quality information 45.

The second embodiment was described on condition that the recording layer quality information 45 is included in the DDS 20. However, it may also be included in the disk management information 21 for instance, in which case the same effect as described here can also be obtained.

According to the first and second embodiments, the unused area such as the BCA 4 or DDS 20 (Reserved area where 0 is set) includes the information which has been nonexistent. For instance, a disk of which recording layer quality information is set as 0 (to be more specific, the quality information 51 is invalid because the enable flag 50 is 0) can be handled as the same one as a conventional disk so that it operates on a conventional apparatus without a problem. Even in the case of a disk of which recording layer quality information has a value other than 0 set therein, that information has not been used from the beginning so that the possibility of a malfunction of the conventional apparatus is low enough to secure the operation on the conventional apparatus. Therefore, there is almost no demerit provided to the user.

### Third Embodiment

(1) Optical Disk Configuration

As the configuration of the optical disk of the third embodiment is the same as the one described in the first embodiment, a description thereof will be omitted here.

(2) Data Structure

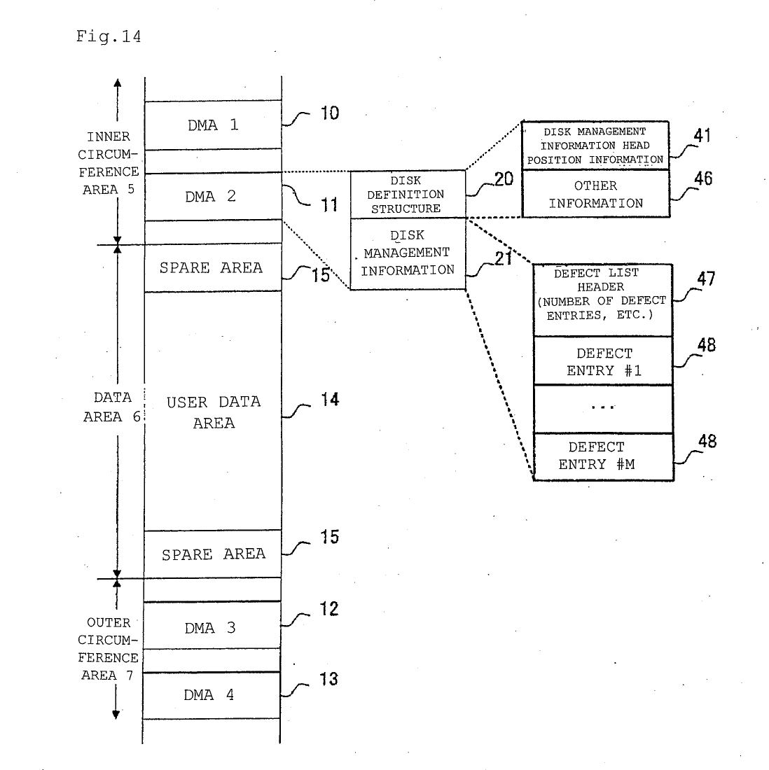

FIG. 14 is a data structure diagram of a certain recording layer of the optical disk 1 according to the third embodiment of the present invention. As the optical disk 1 of the third embodiment is the same as the optical disk 1 of the second embodiment except for the contents of the disk definition structure (DDS) 20 and the disk management information 21, a description of the same portions will be omitted.

The DDS 20 is the information which indicates the structure of the optical disk 1, including at least the disk management information head position information 41 as the information on the head position (=physical address) where the disk management information 21 is placed, the other information 46 and the like. Here, the DDS 20 may include the information such as the disk definition structure identifier 40 as with the DDS 20 of the second embodiment of the present invention which was described by using FIG. 9. However, it does not include the recording layer quality information 45.

In the third embodiment, the disk management information 21 is defect management information, that is, a defect list (called a DFL hereafter), which includes the information such as a defect list header 47 and at least 0 or more defect entry 48.

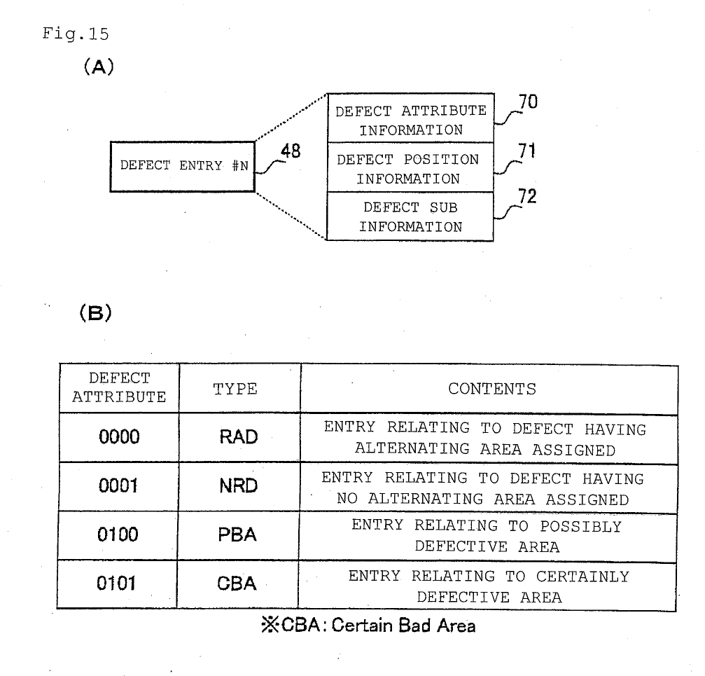

The defect list header 47 is the information including information indicating the number of defect entries 48 and update frequency information included in the DFL, which is the information placed at the head position of the DFL. In the case of FIGS. 15, there are M pieces (M is a positive number of 1 or more) of defect entry 48, and so the information indicating the number of pieces also indicates M.

FIG. 15 are explanatory diagrams relating to the defect entries.

FIG. 15(A) is an explanatory diagram showing a structure of the defect entry 48. The defect entry 48 includes defect attribute information 70, defect position information 71 and defect sub information 72.

The defect position information 71 is the head position information (initial physical address) of the defective block in the data area 6.

The defect sub information 72 is the information which indicates different contents according to the kind of the defect attribute information 70. Details thereof will be described later.

FIG. 15(B) is a table summarizing the kinds of the defect attribute information 70, which takes the BD-RE as an example. In the case of the BD-RE, there are the kinds of defects, such as an RAD which is a defect having the alternating area assigned, an NRD which is a defect having no alternating area assigned and a PBA which is information on a possibly defective area. In the case that the defect attribute information 70 is the RAD, the defect sub information 72 indicates the head position information of an alternation destination block in the spare area 15. In the case of the NRD, it includes no information (=0). In the case of the PBA, it indicates the size information on continuous areas led by the defect position information 71, which may be defective.

The third embodiment further includes a defect attribute called a CBA as the defect attribute information 70. This defect attribute is the information about the area certainly known to be problematic in use for a normal application in disk manufacturing for instance, which is the information obtained in the step 503 of (1) the disk manufacturing process of the first embodiment for instance.

The defect sub information 72 indicates the size information on the defective area. To be more precise, in the case that the 0-th recording layer 502 is an unusable layer in the two-layer disk shown in FIG. 3 for instance, the initial physical address of the recording layer is set in the defect position information 71 while the size of the data area 6 of the recording layer is set as the defect sub information 72.

Thus, the third embodiment is the method of registering a recording layer unusable for a normal application as a defect in the case that such a recording layer exists. As it is physically impossible to register all the blocks 3 of the layer as the defects in the DFL, however, a new defect attribute is provided so as to register the defect as that defect attribute. In this case, being unusable for a normal application means (1) unrecordable or only recordable once in the case of the disk capable of repeated recording as its normal application, and means (2) unrecordable in the case of the disk only recordable once as its normal application. To be more specific, the defect attribute information 70 is an example of the usability information of the present invention having the same contents as the recording layer quality information 45 of the second embodiment.

In the case that there are multiple unusable recording layers of which recording property is NG, there are as many defect entries 48 of a CBA attribute in the DFL as the number of the NG recording layers.

(3) Disk Manufacturing Process

As the configuration of the optical disk recording and reproducing apparatus 100 according to the third embodiment is equivalent to the one described by using FIG. 10 in the above-mentioned second embodiment except for the details of operation of the recording layer quality information control portion 170, a detailed description thereof will be omitted.

The recording layer quality information determining portion 171 included in the recording layer quality information control portion 170 is different from the case in the second embodiment in that it identifies whether or not the entry of which defect attribute is the CBA exists from the defect entry 48 included in the disk management information 21 and thereby determines whether or not there is the unusable recording layer.

The address translation processing portion 172 performs the translation process of the physical address (PBA) and the logical address (LBA) and the like based on the result determined by the recording layer quality information determining portion 171. To be more specific, it does not assign the logical address to the layer specified as unusable by the recording layer quality information determining portion 171 but only assigns the logical address to the layer determined to be usable.

The recording layer quality information setting portion 173 is different from the case in the second embodiment in that it creates the information to be recorded as the entry of the CBA attribute in the defect entry 48 based on the contents specified by the higher-level control apparatus.

The manufacturing process of the optical disk 1 in the third embodiment has the same procedure of the steps 501 to 503 as that described by using FIG. 4 in the first embodiment. Here, a description will be only given as to the details of operation of the step 504 which are different from the first embodiment. A description of the steps 501 to 503 will be omitted.

Step 504: The DDS 20 and the disk management information 21 are recorded on the optical disk 1. Here, the disk management information 21 including the DFL is recorded in the DMAs 1 to 4 of each of the recording layers. The DFL recorded in this case reflects the result of examining the recording property of each of the recording layers in the step 503. In the case that there is a layer of which recording property according to the normal application is NG, the disk management information 21 is recorded, which includes the DFL including the defect entry 48 wherein the initial physical address of the recording layer is the defect position information 71, the size of the data area 6 of the layer is the defect sub information 72 and the defect attribute information 70 is the CBA.

The following shows an example of the step 504.

As an example of the recording process from the DMAs 1 to 4, there is a process called a physical format. The physical format is a process mainly for deciding the structure of the data area 6 (placement of the user data area 14 and the spare area 15 and the like), where the DDS 20 and the disk management information 21 are recorded in the DMAs 1 to 4. Here, the information equivalent to the DDS 20 and the disk management information 21 is stored in the management information storage buffer 150 for instance.

The physical format is specified from the higher-level control apparatus such as a host computer (not shown) by a “Format Unit” command (called a Format command hereafter) of the packet command prescribed by the SFF 8090 standard (also called a Mt. Fuji standard) prescribed by an industry organization of storage devices such hard disks and optical disk drives called SFF (Small Form Factor).

The Format command is equivalent to the one described in the above-mentioned second embodiment, and so a description thereof will be omitted here.

Hereunder, a description will be given by taking as an example the case of recording the DDS 20 and the disk management information 21 in the DMAs 1 to 4 by using the Format command.

A detailed procedure of the step 504 is the same as the procedure described by using FIG. 12 in the above-mentioned second embodiment.

Step 1301: The higher-level control apparatus issues the Format command to the optical disk recording and reproducing apparatus 100. The optical disk recording and reproducing apparatus 100 receives the CDB and the parameter list transmitted from the higher-level control apparatus. In this case, the information equivalent to the recording layer of which recording property is NG is transmitted from the higher-level control apparatus by including it in the CDB or the parameter list for instance.

Step 1302: The order processing portion 110 of the optical disk recording and reproducing apparatus 100 having received the Format command determines whether or not it is possible to set the defect entry 48 of the CBA attribute in the DFL. Here, the following methods are thinkable as the methods for determining whether or not it is possible to set the defect entry 48 of the CBA attribute.

1) To newly provide a layer quality in use information setting mode to the Format command so as to set up the defect entry 48 of the CBA attribute in the case that the mode is requested.

2) To set up the defect entry 48 of the CBA attribute in the case that the DMA area of the optical disk 1 for performing the recording is in an unrecorded state (such as the case where the optical disk 1 is a virgin disk yet to be recorded).

3) A pattern of combination of the above 1) and 2).

As the third embodiment describes the processing in the disk manufacturing process, the above 3) is used as the method of determination. As it is the processing in the disk manufacturing process, however, it is assured in advance that the subject optical disk 1 for performing the recording in the above 2) is a virgin disk. Therefore, the pattern of the above 1) is substantially used.

Step 1303: In the case that the order processing portion 110 determines to set up the defect entry 48 of the CBA attribute, it calculates the defect entry 48 of the CBA attribute to be set up by using the initial physical address and the size of the data area 6 of the recording layer of which recording property according to the normal application is specified as NG. The recording layer quality information setting portion 173 reflects this in the disk management information 21, that is, the information equivalent to the DFL included in the management information storage buffer 150. In this case, the recording layer usable for the normal application is decided so that the position and size of the logical space are also decided.

As described in (4) disk readout process in the first embodiment, in the case that there are multiple usable layers in a four-layer disk for instance, various methods of assigning the logical spaces are thinkable. Therefore, the values to be set here are calculated according to the methods of assigning the logical spaces.

In the case that the order processing portion 110 determines not to set up the defect entry 48 of the CBA attribute, the recording layer quality information setting portion 173 reflects a default value of the defect entry 48 (all 0 for instance) in the information equivalent to the disk management information 21 included in the management information storage buffer 150 and moves on to a step 1304.

Step 1304: Lastly, the order processing portion 110 requests the recording control portion 120 to record the DDS 20 and the disk management information 21 included in the management information storage buffer 150. And the recording control portion 120 records the DDS 20 and the disk management information 21 in the DMAs 1 to 4 of each of the recording layers.

Here, although probability is very low, there may be the case of a failure in the recording in the DMAs 1 to 4 of the recording layers determined to be usable in the recording layer recording property examination in the step 503. In such a case, the disk is determined to be an unusable disk so that it is discarded and not shipped as a product. In the case that the result is different from the details of the recording property of the normal application specified as OK/NG on completing the recording on all the recording layers, it is possible to recalculate the defect entry 48 of the CBA attribute and record the disk management information 21 in the DMAs 1 to 4 of each of the recording layers again.

The above procedure completes the process of the step 504, that is, the process of recording the disk management information 21 on the optical disk 1.

As described above, the optical disk 1 of the third embodiment is shipped in the state of having already been physical-formatted in the manufacturing process.

It is desirable that the defect entry 48 of the CBA attribute set up in the disk manufacturing process be limited as the information which is unchangeable even if the disk is physical-formatted by the user thereafter.

The third embodiment described that the DDS 20 and the disk management information 21 should be recorded in all the DMAs 1 to 4 of each of the recording layers. It is not always necessary, however, to record them in all the DMAs 1 to 4 of all the recording layers. To be more precise, it is sufficient, as a method for having the same effect, to perform the recording to the DMAs 1 to 4 of at least one of the recording layers (such as the recording layer rendered as the virtual 0-th recording layer) which is normally recordable while only recording in a specific DMA (such as the DMA 1) on the other recording layers.

The third embodiment took as an example the case of including the information equivalent to the defect entry 48 of the CBA attribute to be set up in the CDB or the parameter list of the Format command. However, it is also possible, for instance, to store the information in the management information storage buffer 150 provided to the optical disk recording and reproducing apparatus 100 in advance of the Format command process or store the information in a nonvolatile memory (not shown) such as an EEPROM so as to perform the process by using it.

The third embodiment showed an example of recording the DDS 20 including the recording layer quality information 45 in the DMAs 1 to 4 by using the Format command. However, it is not always necessary to use the Format command. It is also possible, for instance, to construct a new command for registering the defect entry 48 of the CBA attribute and perform the recording by using that command.

(4) Disk Readout Process

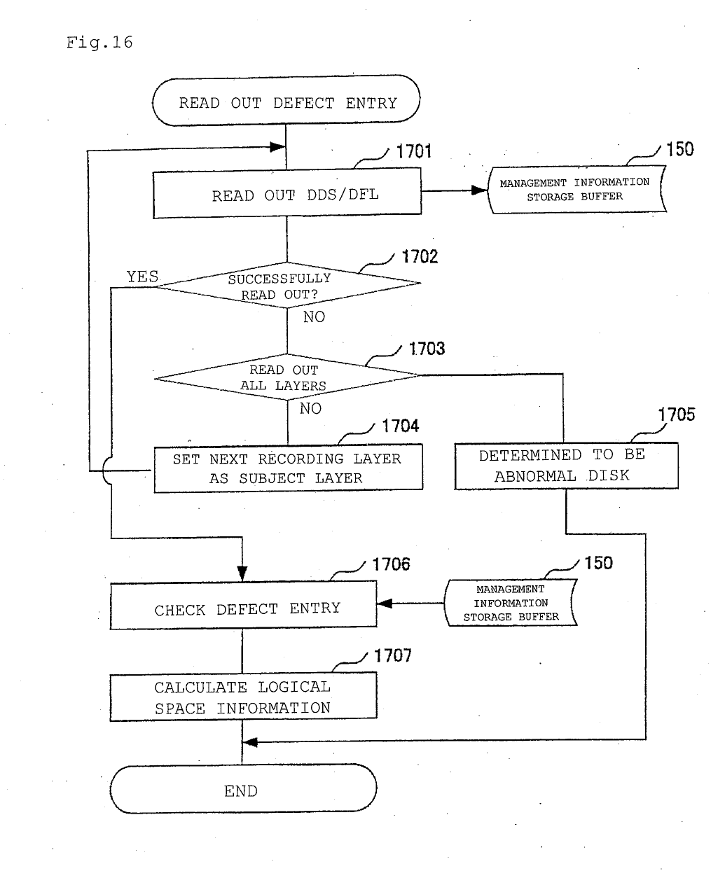

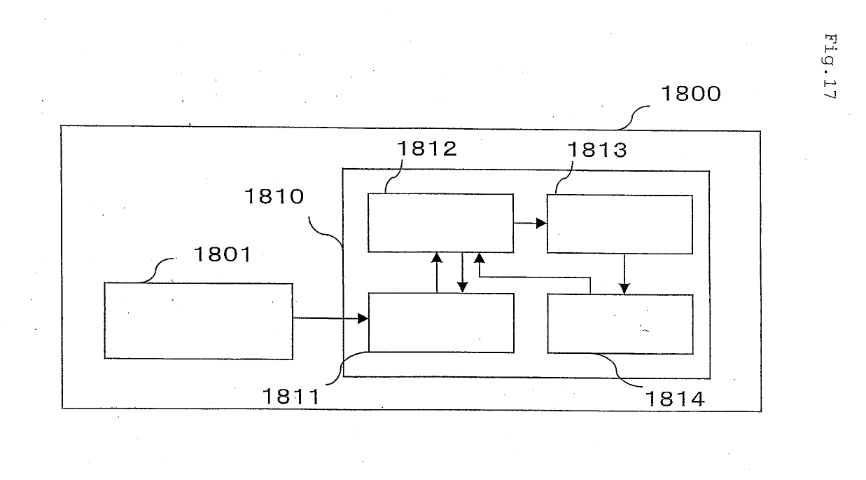

FIG. 16 is a flow diagram showing the disk reading (running) procedure for the optical disk 1 of the third embodiment by the optical disk recording and reproducing apparatus 100.

Step 1701: The reproduction control portion 130 reads out the DDS 20 and the disk management information 21 from the DMA area (DMAs 1 to 4) in a specified recording layer. The recording layer to be read out first is the 0-th recording layer in this case.

Step 1702: The reproduction control portion 130 determines whether or not the data was correctly read out in the step 1701.

If read out, the DDS 20 and the disk management information 21 are stored in the management information storage buffer 150 and the procedure proceeds to a step 1706.

If not correctly read out, the procedure proceeds to a step 1703.

Step 1703: The reproduction control portion 130 determines whether or not the readout of the DMA areas of all the recording layers has been completed.

Step 1704: If it is determined that the readout of the DMA areas of all the recording layers is yet to be completed as a result of the step 1703, the reproduction control portion 130 sets a next recording layer as a subject recording layer and returns to the step 1701 to perform the DMA readout process in the next recording layers. For instance, it sets the next recording layers to be in order of the first recording layer, the second recording layer and the third recording layer with the 0-th recording layer as the recording layer to be determined first.

Step 1705: If it is determined that the readout of the DMA areas of all the recording layers has been completed as a result of the step 1703, the reproduction control portion 130 determines that the optical disk 1 is an abnormal optical disk 1 in a state impossible to handle (such as a state yet to be physical-formatted) so as to complete the readout process.

Step 1706: The recording layer quality information determining portion 171 obtains the defect entries 48 from the disk management information 21, that is, the DFL read out to the management information storage buffer 150, and determines whether or not the defect entry 48 of the CBA attribute exists among them.

Step 1707: The address translation processing portion 172 calculates the logical space information from the result of the step 1706. To be more precise, if it is determined that there is no defect entry of the CBA attribute in the step 1706, the address translation processing portion 172 determines that all the recording layers are usable. And it performs the calculation on condition that the head of the user data area 14 in the 0-th recording layer is the head position of the logical space and the size having the sizes of the user data areas 14 in all the recording layers added together is the logical space size. If it is determined that the defect entry 48 of the CBA attribute exists, the logical space is calculated with the recording layer eliminated which is set up as the defect entry 48 of the CBA attribute. As there are various methods of calculating the logical space as described in the above-mentioned first embodiment, the calculation is performed in accordance therewith.

The above completes the disk reading (running) process for the optical disk 1 in the third embodiment.

In the steps, the step 1701 is equivalent to (a) the step of reading out the usability information in the preparation method for use of the information recording medium of the present invention. The steps 1702 to 1706 are equivalent to (b) the steps of determining at least whether or not the usability is adverse in the preparation method for use of the information recording medium of the present invention. And the step 1707 is equivalent to (c) the step of assigning the logical addresses in the preparation method for use of the information recording medium of the present invention.

Here, it may also be described that the DDS 20 is read out from the DMA areas of all the recording layers, and it is determined that the optical disk 1 is normal only when all the pieces of information match as described in the above-mentioned second embodiment. Even in this case, it is possible to obtain the same effect as described here.

It was also described here that the DDS 20 and the disk management information 21 are read out from all the DMA areas of the DMAs 1 to 4. However, the disk management information 21 does not always have to be read out. And it is not always necessary to read out all the four DMA areas of all the recording layers, but the same effect as described here can be obtained by only reading out a predetermined DMA area.

It is also possible to hold the information of the recording layer of which readout is determined to be success/failure in the step 1702 in the management information storage buffer 150 for instance so as to compare it with whether or not the defect entry 48 of the CBA attribute exists as the defect entry 48. To be more specific, the comparison can be made on the assumption that the readout from all the recording layers should be successful in the case that the defect entry 48 of the CBA attribute does not exist while the readout from the recording layer specified by the defect entry 48 of the CBA attribute should fail in the case that it exists. There is a possibility in general, however, that the readout of the data from the recording layer specified as unusable may be successful. Therefore, it is possible to improve reliability of the data by checking whether or not the readout from the recording layer specified as usable was successful.

The third embodiment was described by taking as an example the case where it is not sure which recording layer has the DMA having been normally recorded. It is also possible, however, to provide a reference recording layer for instance. To be more specific, in the case of the four-layer disk for instance, the 0-th recording layer is decided on as the reference recording layer for instance so that the 0-th recording layer is handled as capable of normal recording (with the recording property at a sufficient level as a product) without fail. And the disk which failed in the DMA recording of the 0-th recording layer may be caused not to be shipped as a product by considering it as a defective disk. Thus, the DDS 20 and the disk management information 21 are correctly recorded in the DMA area of the 0-th recording layer as the reference recording layer without fail. Therefore, in the case of using this disk, the optical disk recording and reproducing apparatus 100 can obtain the same effect as described here by reading out the disk management information 21 and the like from the DMA area of the 0-th recording layer, obtaining the defect entry 48 and performing the processing thereafter based on this information.

The third embodiment was described on condition that the recording layer registered as the defect entry 48 of the CBA attribute is totally unusable. However, it is also possible as a method, according to the user's will, to include an instrument which renders the unusable recording layer usable, that is, an instrument which ignores the defect entry 48 of the CBA attribute.

The third embodiment also described the method of registering a totally unusable layer as a defect. In this case, however, all the existing recording layers look existent as-is, which is different from the cases of the first embodiment and the second embodiment where the disk is handled as a disk virtually including a small number of recording layers.

It is also possible, in the first to third embodiments, to record some data on the unusable recording layer and change it from the unrecorded state to the recorded state on shipment for instance in order to improve recording and reproduction performance and access performance.

According to the first embodiment, the recording layer quality information was stored in the BCA provided further on the inner circumference side of the optical disk 1 than the side on which the annular recording layers 502 and 503 are provided as shown in FIG. 18. As for the usability information of the present invention, however, it is not limited to the BCA if further on the inner circumference side than annular rings composed of the recording layers so as not to influence the recording or reproduction of information on each of the recording layers. It may also be directly stored on a disk substrate layer further on the inner circumference side than that. And it may also be directly stored further on the outer circumference side than the annular rings of the recording layers.

According to the second and third embodiments, the recording layer quality information was stored in the DMA of the inner circumference area 5 or the outer circumference area 7 sandwiching the data area 6 on the recording layer as shown in FIGS. 9 and 14. As for the usability information of the present invention, however, it is possible to use an arbitrary location of another area on the recording layer, such as the spare area 15, if there is no influence on the recording or reproduction of the information on each of the recording layers.

The first to third embodiments were described on condition that the recording layer quality information is the information which is optically readable by the optical disk recording and reproducing apparatus 100. However, the usability information of the present invention is not limited thereto. It may also be the information which is embedded at a predetermined location of the optical disk 1 in the form of an IC tag or the like to be magnetically readable from outside.

The first to third embodiments described that the recording portions of the present invention are multiple laminated recording layers. However, the recording portions may also be concentrically provided in the same plane respectively.

The first to third embodiment took the BD-RE which is a high-density optical disk as an example of the optical disk. However, the present invention is not limited thereto. It may also be implemented by a DVD-R, DVD-RAM or the like without limiting it to that format as long as it is a structure in which the recording layers are laminated and the information is optically recorded or reproduced.

The first to third embodiments described each of the steps shown in the steps 501 to 504 as (3) Disk manufacturing process respectively. However, the present invention may also be implemented as a disk manufacturing apparatus which collectively performs the steps of the process. FIG. 17 is a block diagram of such a disk manufacturing apparatus 1800. As shown in FIG. 17, the disk manufacturing apparatus 1800 comprises a gluing instrument 1801 which performs the step 501 and creates a medium body of the optical disk by gluing together a substrate material and a recording film material and a recording apparatus 1810 which performs the steps 501 to 504 and records the usability information on the medium body.

The recording apparatus 1810 includes a drive system 1811 for driving the medium body, an optical system 1812 for reading out or writing the information from or to the medium body set on the drive system 1811, an examination portion 1813 for executing the examinations of the steps 502 and 503 by obtaining the information read out by the optical system 1812 and a usability information generating portion 1814 for generating the usability information based on an examination result of the examination portion 1813. The optical system 1812 also performs the operation of optically writing the usability information from the usability information generating portion 1814 to a predetermined position (the BCA in the first embodiment or the DMA in the second and third embodiments) of the medium body.

In the above configuration, the manufacturing apparatus 1800 is equivalent to the manufacturing apparatus of the information recording medium of the present invention, and the recording apparatus 1810 is equivalent to the recording apparatus of the information recording medium of the present invention. The optical system 1812 is equivalent to a description instrument of the present invention. The recording apparatus 1810 may be used independently from the manufacturing apparatus 1800. It was described that the examination portion 1813 and the usability information generating portion 1814 are integral with the manufacturing apparatus 1800. However, the examination portion 1813 and the usability information generating portion 1814 may be separate as a configuration so that the manufacturing apparatus 1800 operates by obtaining the usability information from outside. In this case, the examination portion 1813 and the usability information generating portion 1814 can use a conventional optical drive for examination as-is. It is also possible to perform the step of examining the usability of the present invention and the step of storing the usability information at the predetermined location at distant places.

### INDUSTRIAL APPLICABILITY

The information recording medium, manufacturing method thereof, processing apparatus thereof, preparation method for use thereof, information recording method and information recording apparatus according to the present invention have the effect of allowing efficient use of the recording layers according to the extent of the problem if the problem occurs to one of the recording layers. For instance, they are useful being applicable to manufacturing of the optical disk including multiple recording layers and the optical disk drive apparatus capable of recording and reproducing the optical disk including multiple recording layers.

1. An information recording medium comprising a plurality of recording layers, wherein usability information relating to usability of each of the plurality of recording layers is stored at a predetermined location.

2. The information recording medium according to claim 1, wherein the usability information indicates that the recording layers are in at least one of the states of (1) unrecordable, and (2) recordable.

3. The information recording medium according to claim 2, wherein (2) recordable of the usability information indicates one of the states of (2a) recordable only once and (2b) repeatedly recordable.

4. The information recording medium according to claim 1, wherein all the plurality of recording layers are in a shape of an annular ring and the predetermined location is provided further on the inner circumference side than the annular ring.

5. The information recording medium according to claim 4, wherein the predetermined location is a BCA (Burst Cutting Area).

6. The information recording medium according to claim 1, which is an optical disk, wherein all the plurality of recording layers are in the shape of an annular ring and the predetermined location is an arbitrary location on the recording layer.

7. The information recording medium according to claim 6, wherein the arbitrary location is a disc management area (DMA) in which management information relating to the optical disk is recorded.

8. The information recording medium according to claim 7, wherein:
the DMA has disk management information which is management information relating to the optical disk and a DDS (Disc Definition Structure) including positional information on a position for placing the disk management information stored therein; and
the predetermined location is a location for storing the disk management information or a location for storing the DDS.

9. A recording apparatus of an information recording medium for recording information on the information recording medium including a plurality of recording layers, comprising a description instrument which stores a result of usability of each of the plurality of recording layers as usability information relating to the usability which is the information at a predetermined location.

10. The recording apparatus of an information recording medium according to claim 9, wherein the usability information indicates that the recording layers of the information recording medium are in at least one of the states of (1) unrecordable, and (2) recordable.

11. The recording apparatus of an information recording medium according to claim 10, wherein (2) recordable of the usability information indicates one of the states of (2a) recordable only once and (2b) repeatedly recordable.

12. The recording apparatus of an information recording medium according to claim 9, wherein:
the information recording medium is an optical disk in which the plurality of recording layers are formed on a disk substrates
all the plurality of recording layers are in a shade of an annular ring;
an examination of the usability is performed by optically recording or reproducing the information on each of the recording layers; and
the predetermined location is an arbitrary location selected from at least the disk substrate and each of the recording layers.

13. The recording apparatus of an information recording medium according to claim 12, wherein the arbitrary location is a BCA (Burst Cutting Area) which is formed further on the inner circumference side than the annular ring of the plurality of recording layers of the disk substrate.

14. The recording apparatus of an information recording medium according to claim 12, wherein the arbitrary location is a disc management area (DMA) in which management information relating to the optical disk is recorded.

15. A manufacturing apparatus of an information recording medium including a plurality of recording layers, comprising:
a gluing instrument which creates a medium body including the plurality of recording layers by laminating and gluing together a plurality of recording films on a disk substrate; and
the recording apparatus of the information recording medium according to claim 9,
wherein the information recording medium having the usability information recorded thereon is created by recording the usability information on the medium body.

16. A recording method of an information recording medium for recording information on an information recording medium including a plurality of recording portions, comprising:
(a) a step of examining usability of each of the plurality of recording layers; and
(b) a step of storing a result of the examination as usability information relating to the usability which is the information at a predetermined location.

17. The recording method of an information recording medium according to claim 16, wherein the usability information indicates that the recording layers of the information recording medium are in at least one of the states of (1) unrecordable, and (2) recordable.

18. The recording method of an information recording medium according to claim 17, wherein (2) recordable of the usability information indicates one of the states of (2a) recordable only once and (2b) repeatedly recordable.

19. A manufacturing method of an information recording medium including a plurality of recording layers, comprising:
(a) a step of creating a medium body including the plurality of recording layers by laminating and gluing together a plurality of recording films on a disk substrate; and
(b) a step of recording the usability information on the medium body by the recording method of an information recording medium according to claim 16.

20. A processing apparatus of an information recording medium for performing a process of rendering the information recording medium according to claim 1 usable, comprising:
a readout instrument which reads out the usability information from the predetermined location of the information recording medium;
a determination instrument which determines a degree of usability as to each of the plurality of recording layers based on the usability information read out by the readout instrument; and
an assignment instrument which renders data areas in the recording layers of which usability is determined at least not to be adverse by the determination instrument as recordable or reproducible logical spaces and assigns logical addresses which are addresses of the logical spaces.

21. The processing apparatus of an information recording medium according to claim 1, wherein the assignment instrument assigns the logical addresses in order from the recording layer close to the side where the readout is performed out of the recording layers of which usability is determined at least not to be adverse.

22. The processing apparatus of an information recording medium according to claim 16, wherein the assignment instrument assigns the logical addresses in a direction matching with an assignment direction of physical addresses of each of the recording layers of which usability is determined at least not to be adverse and an assignment direction of physical addresses among the recording layers.

23. A preparation method for use of an information recording medium for rendering the information recording medium according to claim 1 usable, comprising:
(a) a step of reading out the usability information from the predetermined location of the information recording medium;
(b) a step of determining at least whether or not usability is adverse as to each of the plurality of recording layers based on the usability information read out in the step (a); and
(c) a step of rendering data areas in the recording layers of which usability is at least determined not to be adverse in the step (b) as recordable or reproducible logical spaces and assigning logical addresses which are addresses of the logical spaces.
